(19) United States
(12) Patent Application Publication
(10) Pub. No.: US 2007/0175912 A1
(43) Pub. Date: Aug. 2, 2007

(54) SHEET SORTING METHOD AND APPARATUS

(75) Inventors: Mitsuhiro Uehara, Noda-Shi (JP); Kenji Hayashi, Noda-Shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/622,399

(22) Filed: Jan. 11, 2007

(30) Foreign Application Priority Data
Jan. 12, 2006 (JP) 2006-4558

(51) Int. Cl. G07F 11/72; B23Q 7/12

(52) U.S. Cl. 221/30; 221/163

(57) ABSTRACT

Disclosed is a sheet sorting method in which, on paper sheets each with a plurality of identical patterns printed thereon side by side in a longitudinal direction and in a lateral direction, a quality of the patterns thereof is inspected; in a case where the quality of the patterns on the sheets in all of groups into which the plurality of patterns are grouped is determined to be non-defective, these paper sheets are discharged to non-defective sheet discharge locations; in a case where a defect is determined to exist among the patterns in only one of the groups on each of the sheets, these paper sheets are discharged to single-column defective discharge locations (single-group defective sheet discharge locations); and in a case where defects are determined to exist among the patterns in a plurality of groups on each of the sheets, these paper sheets are discharged to plural-group defective discharge locations.

### BACKGROUND OF THE INVENTION

1. Field of the Invention

The present invention relates to a method of, and an apparatus for, sorting printed sheets by printing conditions.

2. Description of the Related Art

As a printing press for printing bank notes and securities, there is one provided with a quality inspection device between a printing unit and a delivery unit. In such a printing press, a large number of patterns (each corresponding to, for example, a bank note or a security), are printed in a matrix on each of sheets in the printing unit. Then, non-defective and defectives of the thus printed sheets are identified by the quality inspection device. Thereby, the non-defectives are delivered onto a delivery board for non-defectives in the delivery unit, and the defectives are delivered onto a delivery board for defectives. Even one defect on any one of the large number of printed patterns in a matrix on the sheet causes this sheet to be identified as a defective.

The applicant of the present invention has applied for a patent for “Sheet Discrimination Method and Discrimination Apparatus” for sorting printed sheets by printing conditions, and the application has been disclosed as Japanese Patent Application Laid-Open No. 2002-1923. An invention according to this application is configured to sort sheets, on each of which patterns, have been printed in a matrix, into non-defectives, blank sheets, defectives and partially defective sheets. Thereby, the sheets are not wasted. Accordingly, it is made possible to achieve reduction in costs for printing the sheets.

Among the sorted sheets, those determined as the partially defective sheets are again inspected by a human inspector in a subsequent step. In this inspection, a worker finds a defective pattern from the large number of printed patterns in a matrix by visual inspection. The worker then manually makes a mark on a part corresponding to that defective pattern. This work requires a large amount of manpower and labor. Because such inspections are visually performed by a worker, the criteria for distinguishing non-defectives from defectives may possibly differ among individual workers.

Each of the sheets determined as the defectives is cut into pieces of a small size (a size of one piece of bank note or security) by a cutting machine. The pieces cut into a small size are sorted into non-defectives and defectives. Thereafter, numbers are printed on the respective pieces one by one by use of a numbering machine exclusively for small-cut pieces. A numbering machines dedicated to a large number of small-cut pieces are obviously needed.

Moreover, particularly in the printing of bank notes, securities and the like, a method of, and an apparatus for sorting, where post-printing processes are performed more easily, is awaited. It is also demanded that inspections for sorting be performed with a single criterion which does not depend on individual workers. Furthermore, it is demanded that processes after sorting, such as number printing, be performed by utilizing existing equipment as much as possible. Reduction in manpower required for the inspections is also demanded.

### SUMMARY OF THE INVENTION

The present invention has been made to respond to these demands.

A sheet sorting method according to a first aspect of the present invention is a sorting method, in which sheets, each of which with a plurality of patterns printed thereon, are inspected with respect to a printing quality of the patterns thereof, and in which the sheets are sorted, and are discharged on the basis of results of the inspections. The method is characterized in that the sheets are sorted into, and are discharged as: non-defective sheets on which all of the patterns are determined as non-defectives or perfect; single-group defective sheets each determined to have a defective pattern only in one group out of a plurality of groups formed by grouping the plurality of patterns into the plurality of groups; and plural-group defective sheets each determined to have a defective pattern in each of a plurality of groups out of the plurality of groups into which the plurality of patterns are grouped.

In this method, whether the printed sheets are non-defective or defective is determined not by a visual inspector, but by an optical and electronic method using a CCD camera or the like. Incidentally, with regard to the above expression, “a plurality of groups out of the plurality of groups,” “a plurality of groups” mentioned first includes at least two or all of the groups among “the plurality of groups” mentioned next.

A sheet sorting method according to a second aspect of the present invention is characterized in that, in addition to the first aspect, a plurality of patterns are printed in a longitudinal direction and in a lateral direction on each of the sheets, and each of the groups is formed of any one of: patterns in each of the columns extending in the longitudinal direction; patterns in each of the rows extending in the lateral direction; and a predetermined number of patterns extending across a plurality of columns or rows.

A sheet sorting method according to a third aspect of the present invention is characterized in that, in addition to any one of the first and second aspects, a mark is placed on a defective pattern on each of the single-group defective sheets.

A sheet sorting method according to a fourth aspect of the present invention is characterized in that, in addition to any one of the first and second aspects, the single defective sheets, which have a defective pattern in the same group as that of one another, are sorted out, and discharged.

A sheet sorting method according to a fifth aspect of the present invention is characterized in that, in addition to any one of the first and second aspects, numbers are printed on the patterns in the groups on the single-group defective sheets in which groups non-defective patterns exist.

A sheet sorting method according to a sixth aspect of the present invention is, in addition to the fifth aspect, characterized by including the steps of: cutting the single-group defective sheets, on which numbers are printed, into the patterns, thereby making them into small-cut piece printed products; and subsequently sorting the small-cut printed products into those with non-defective patterns, and with numbers printed thereon, those with non-defective patterns, and without numbers printed thereon, and those with defective patterns.

A sheet sorting method according to a seventh aspect of the present invention is, in addition to any one of the first and second aspects, characterized by including the steps of: cutting the plural-group defective sheets into the patterns, and thereby making them into small-cut piece printed products; and subsequently sorting the small-cut piece printed products into those with non-defective patterns, and those with defective patterns.

A sheet sorting method according to an eighth aspect of the present invention is characterized in that, in addition to the first aspect, the non-defective sheets are discharged to a non-defective sheet discharge location, the single-group defective sheets are discharged to a single-group defective sheet discharge location, and the plural-group defective sheets are discharged to a plural-group defective sheet discharge location.

A sheet sorting method according to a ninth aspect of the present invention is characterized in that, in addition to the first aspect, by inspecting a quality of each of the sheets more than once, the sheets are sorted into, and are discharged as, the non-defective sheets, the single-group defective sheets and the plural-group defective sheets.

A sheet sorting method according to a tenth aspect of the present invention is, in addition to the ninth aspect, characterized by including the steps of: sorting the non-defective sheets, the single-group defective sheets and the plural-group defective sheets into sheets of a specific kind and remaining sheets, and thereby discharging the sorted sheets; inspecting the quality of the remaining sheets again when a plurality of kinds of sheets among the non-defective sheets, the single-group defective sheets and the plural-group defective sheets are mixed in the remaining sheets; and thus sorting out the sheets of the specific kind out of the remaining sheets, and thereby discharging the sorted sheets.

The sheets of the specific kind in this aspect include sheets of any one kind selected from the kinds corresponding to the non-defective sheets, any one type of the single-group defective sheets, and the plural-group defective sheets. Sheets not selected. here are the remaining sheets. Notions herein described for the sheets of a specific kind, and for the remaining sheets are the same as those in the following descriptions.

A sheet sorting method according to an eleventh aspect of the present invention is characterized in that, in addition to the tenth aspect, inspection on the quality of the remaining sheets, and the sorting out and the discharging sheets of the specific kind are repeated until the remaining sheets do not include a plurality of kinds of sheets.

A sheet sorting method according to a twelfth aspect of the present invention is, in addition to the tenth aspect, characterized by including the steps of: sorting out, and discharging the non-defective sheets and the remaining sheets by an initial inspection on a printing quality; subsequently sorting out, and discharging the single-group defective sheets of one type or the single-group defective sheets of a plurality of types which are sorted out and discharged by types, and the remaining sheets, by an inspection on the printing quality of the remaining sheets; sorting out, and discharging at least the single-group defective sheets of one of the types, and the remaining sheets; and sorting out, and discharging the single-group defective sheets by inspecting the printing quality until the remaining sheets include only the plural-group defective sheets.

A sheet sorting method according to a thirteenth aspect of the present invention is characterized in that, in addition to the ninth aspect, a number of plurality of discharge locations where the sheets are discharged is set smaller than a total number of sorts of non-defective sheets, single-group defective sheets, and plural-group defective sheets, which are finally shorted out and discharged, and that, every time printing quality is inspected, one or more discharge locations among the plurality of discharge locations are set as one type or a plurality of types of discharge locations among a non-defective sheet discharge location where the non-defective sheets are discharged, a single-group defective sheet discharge location where the single-group defective sheets are discharged, a plural-group defective sheet discharge location where the plural-group defective sheets are discharged, and a remaining sheet discharge location where the remaining sheets, which mixedly include a plurality of kinds of sheets among the non-defective sheets, the single-group defective sheets and the plural-group defective sheets, are discharged.

A sheet sorting method according to a fourteenth aspect of the present invention is characterized in that, in addition to the thirteenth aspect, in the remaining sheets, a plurality of kinds of sheets among the non-defective sheets, the single-group defective sheets, and the plural-group defective sheets are mixed.

A sheet sorting method according to a fifteenth aspect of the present invention is characterized in that, in addition to the first aspect, the non-defective sheets, the single-group defective sheets and the plural-group defective sheets are sorted out, and are discharged by inspecting a printing quality of each of the sheets once.

A sheet sorting apparatus according to a sixteenth aspect of the present invention is a sorting apparatus which inspects, by use of an inspection device, sheets each with a plurality of patterns printed thereon, with respect to a printing quality of the patterns, and which sorts and discharge the sheets on the basis of results of the inspections. The apparatus is characterized by including: discharge means which discharges the sheets inspected by the inspection device; and control means which controls the discharge means on the basis of the results of the inspections so that the discharge means is allowed to sort out, and discharge the sheets as: non-defective sheets on which all of the patterns are determined as non-defectives; single-group defective sheets each determined to have a defective pattern only in one of a plurality of groups formed by grouping the plurality of patterns into the plurality of groups; and plural-group defective sheets each determined to have a defective pattern in each of a plurality of groups among the plurality of groups into which the plurality of patterns are grouped.

A sheet sorting apparatus according to a seventeenth aspect of the present invention is characterized in that, in addition to the sixteenth aspect, a plurality of patterns are printed in a longitudinal direction and in a lateral direction on each of the sheets, and that each of the groups is formed of any one of: patterns in each of the columns extending in the longitudinal direction; patterns in each of the rows extending in the lateral direction; and a predetermined number of patterns extending across a plurality of columns or rows.

A sheet sorting apparatus according to an eighteenth aspect of the present invention is, in addition to any one of the sixteenth and seventeenth aspects, characterized by further including a marking device which places a mark on a pattern of which quality is determined to be defective by the inspection device.

A sheet sorting apparatus according to a nineteenth aspect of the present invention is characterized in that, in addition to the sixteenth aspect, the control means controls the discharge means so that the discharge means is allowed to sort out, and discharge the single defective sheets which have a defective pattern in the same group as that of one another.

A sheet sorting apparatus according to a twentieth aspect of the present invention is characterized in that, in addition to the sixteenth aspect, the discharge means includes: non-defective sheet discharge means which discharges the non-defective sheets to a non-defective sheet discharge location; single-group defective sheet discharge means which discharges the single-group defective sheets to a single-group defective sheet discharge location; and plural-group defective sheet discharge means which discharges the plural-group defective sheets to a plural-group defective sheet discharge location.

A sheet sorting apparatus according to a twenty-first aspect of the present invention is characterized in that, in addition to the sixteenth aspect, the control means controls the discharge means in a way that the discharge means: sorts the non-defective sheets, the single-group defective sheets and the plural-group defective sheets into sheets of a specific kind and the remaining sheets; discharges the thus sorted sheets; sorts the sheets of the specific kind out of the remaining sheets on the basis of inspections on the quality of the remaining sheets mixedly including a plurality of kinds of sheets among the non-defective sheets, the single-group defective sheets and the plural-group defective sheets; and discharges the thus sorted sheets.

A sheet sorting apparatus according to a twenty-second aspect of the present invention is, in addition to the sixteenth aspect, characterized by further including a plurality of discharge locations where sheets are discharged by the discharge means. The apparatus is also characterized in that a number of discharge locations is set smaller than a total number of sorts of non-defective sheets, single-group defective sheets, and plural-group defective sheets, which are finally sorted out and discharged, and that, every time a printing quality is inspected, the control means sets one or more discharge locations among the plurality of discharge locations as one type or a plurality of types of discharge locations among: a non-defective sheet discharge location where the non-defective sheets are discharged; a single-group defective sheet discharge location where the single-group defective sheets are discharged; a plural-group defective sheet discharge location where the plural-group defective sheets are discharged; and a remaining sheet discharge location where the remaining sheets, which mixedly include a plurality of kinds of sheets among the non-defective sheets, the single-group defective sheets and the plural-group defective sheets, are discharged.

A sheet sorting apparatus according to a twenty-third aspect of the present invention is characterized in that, in addition to the twenty-second aspect, a plurality of kinds of sheets among the non-defective sheets, the single-group defective sheets and the plural-group defective sheets are mixed in the remaining sheets.

A sheet sorting apparatus according to a twenty-fourth aspect of the present invention is, in addition to the sixteenth aspect, characterized by further including a plurality of discharge locations where sheets are discharged. The apparatus is also characterized in that discharge locations, of which number is equal to that of sorts of sheets finally sorted out and discharged, are provided, the sorts corresponding to the non-defective sheets, the single-group defective sheets and the plural-group defective sheets.

A sheet sorting apparatus according to a twenty-fifth aspect of the present invention is, in addition to the sixteenth aspect, characterized by further including transport means which transports the sheets. The apparatus is also characterized in that the transport means is formed by being provided with a sheet gripping device which grips and releases the sheets.

A sheet sorting apparatus according to a twenty-sixth aspect of the present invention is characterized in that, in addition to the sixteenth aspect, the inspection device is configured to photograph patterns on the sheets transported by transport means.

According to the sheet sorting method of any one of the first to fifteenth, and sixth to eleventh aspects of the present invention, the sheets are sorted, and thus processes subsequent thereto are performed easily. To be specific, it is made possible to simultaneously print numbers, by means of an existing numbering and imprinting machine, on the sheets which are defectives of the same type (for example, the sheets which have defectives only in the same group). By printing numbers in this manner, it is made possible to reduce the number of numbering and imprinting machines dedicated to small-cut pieces. Moreover, it is made possible to reduce manpower required for the inspections. By performing the inspections by use of the inspection device, variation in inspections also can be eliminated.

The sheet sorting method of the second aspect makes it possible to process patterns printed on each of the sheets by groups (for example, by columns).

According to the sheet sorting method of the third aspect, a non-defective or defective condition of every pattern is made apparent. Hence, sorting by small-cut printed products is made easy.

The sheet sorting method of the fourth aspect makes it easy to perform subsequent sorting processes on the single-column defective sheets.

The sheet sorting method of the fifth aspect makes it possible to print numbers on each of the sheets. Thus, it is made possible to reduce an amount of number printing subsequently performed on the small-cut piece printed products. As a result, a number of numbering and imprinting machines dedicated to the small-cut pieces can be reduced.

The sheet sorting method of the sixth aspect makes it possible to perform sorting by small-cut piece printed products. Thereby, it is made possible to minimize waste of printed products.

The sheet sorting method of the seventh aspect makes it possible to perform sorting by small-cut piece printed products. Thereby, it is made possible to minimize waste of printed products.

The sheet sorting method of any one of the ninth to fourteenth aspects makes it possible to perform predetermined sorting by repeating the same operation. Thereby, a sorting operation can be simplified. Moreover, the sheet sorting method of any one of the thirteenth and fourteenth aspects makes it possible to reduce the number of discharge locations as equipment for executing the sorting operation. Hence the equipment can be simplified.

The sheet sorting method of the fifteenth aspect makes it possible to sort all of the kinds of sheets by inspecting a quality thereof once. Thereby, time required for sorting can be reduced.

According to the sheet sorting apparatus of any one of the sixteenth to twenty-sixth aspects, variation in determination on whether patterns are non-defectives or defectives can be eliminated. Moreover, subsequent sorting processes are also made easy. It is also possible to reduce manpower required for the inspections. Furthermore, because the sheet sorting apparatus can be combined to a delivery unit of a printing press, it is made possible to simplify the apparatus, and to reduce costs for equipment.

The sheet sorting apparatus of the seventeenth aspect makes it possible to process patterns printed on each of the sheets by groups (for example, by columns).

According to the sheet sorting apparatus of the eighteenth aspect, a non-defective or defective condition of every pattern is made apparent. Thereby, this makes it easy to perform sorting by small-cut printed products.

The sheet sorting apparatus of the nineteenth aspect makes it easy to perform subsequent sorting processes on the single-column defective sheets.

According to the sheet sorting apparatus of the twenty-second aspect, the apparatus is configured with a small number of discharge locations. Hence, the apparatus can be simplified.

The sheet sorting apparatus of the twenty-fourth aspect makes it possible to sort all of the kinds of sheets by inspecting a quality thereof once. Thereby, time required for sorting can be reduced.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of an entire printing press to which a method of, and an apparatus for, sorting sheets according to one embodiment (Embodiment 1) of the present invention;

FIG. 2 is an enlarged schematic side view of a part of a sorting apparatus of the printing press shown in FIG. 1;

FIG. 3 is a side view showing details of a delivery cam device as discharge means in FIG. 2;

FIG. 4 is a block diagram of a control system according to the embodiment;

FIG. 5 is a partially cut exploded view of a numbering and imprinting machine;

FIG. 6 is a cross-sectional view taken along a VI-VI line of FIG. 5;

FIG. 7 is a set of diagrams for explaining sorting;

FIGS. 8A to 8H are diagrams for explaining sorting;

FIG. 9 is a flowchart of a print mode;

FIG. 10 is a flowchart of a Sort 1 mode;

FIG. 11 is a flowchart of a Sort 2 mode;

FIG. 12 is a flowchart of a Sort 3 mode;

FIG. 13 is a flowchart of number printing on a non-defective paper sheet;

FIG. 14 is a flowchart of cutting after the number printing;

FIG. 15 is a flowchart of number printing on a paper sheet with a defective pattern in a single column;

FIG. 16 is a flowchart of cutting after the number printing;

FIG. 17 is a flowchart of a procedure of sorting processes on small-cut piece printed products;

FIG. 18 is a flowchart of number printing on small-cut pieces;

FIG. 19 is a flowchart of the cutting of a paper sheet with defective patterns in a plurality of columns;

FIGS. 20A to 20D are a schematic views showing states respectively after sorting processes in the embodiment;

FIG. 21 is a schematic side view of a sorting apparatus according to another embodiment;

FIG. 22 is a plan view of a paper sheet, showing one example of a different manner of grouping; and

FIG. 23 is a diagram for explaining number printing performed on groups shown in FIG. 22.

### DETAILED DESCRIPTION OF THE INVENTION

Hereinbelow, embodiments of a method of, and an apparatus for, sorting according to the present invention will be described in detail on the basis of the drawings.

### EMBODIMENT 1

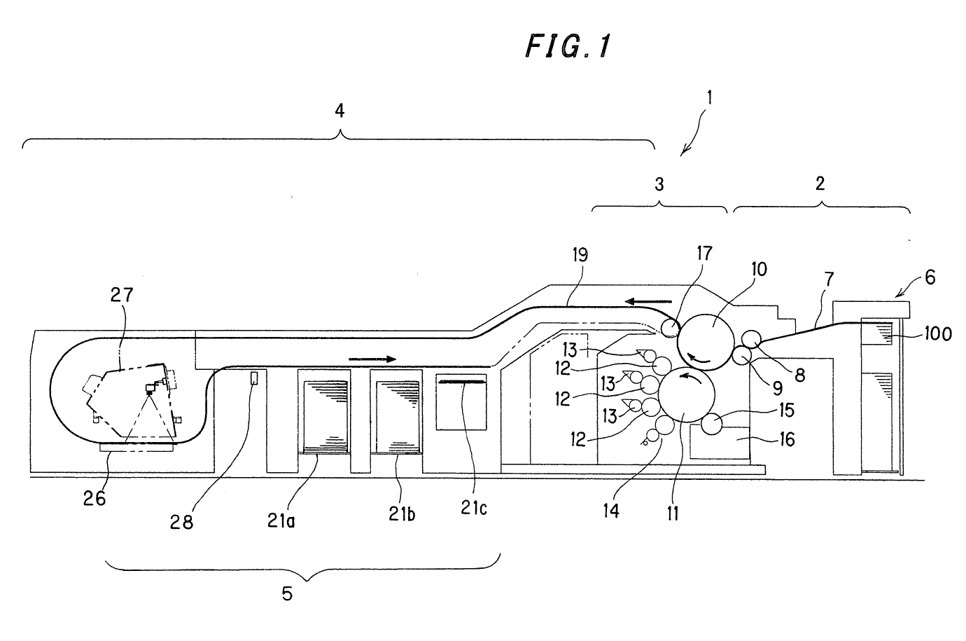

As shown in FIG. 1, a printing press 1 is formed of a feeder 2, a printing unit 3 situated next thereto, and a delivery unit 4 next to the printing unit 3. The delivery unit 4 is equipped with a sorting apparatus 5, which executes the sorting method according to one embodiment of the present invention, and which also corresponds to the embodiment of the present invention.

The feeder 2 is provided with a paper feeding device 6 for feeding paper sheets 100 one by one, the paper sheets 100 being sheets stacked on one another. Each of the paper sheets 100 fed by the paper feeding device 6 is transferred to transfer cylinders 8 and 9 via a feeder board 7 and an unillustrated swing arm shaft pregripper. Then, each of paper sheets 100 is transferred to an impression cylinder 10 from the transfer cylinder 9.

In the printing unit 3, an intaglio cylinder 11 abuts on the impression cylinder 10. Three chablon rollers 12 abut on the intaglio cylinder 11. The chablon rollers 12 have inking devices 13 connected thereto. Thereby, the chablon rollers 12 supply ink to predetermined locations of the intaglio cylinder 11, the ink being transferred from the inking devices 13. A pre-wiping device 14 for wiping out an excess of ink supplied from the chablon rollers 12 is arranged in a way that the pre-wiping device 14 abuts on a part of the intaglio cylinder 11 below a location where one of the chablon rollers 12 abuts on the intaglio cylinder 11 at the lowest level among locations where the chablon rollers 12 abut on the intaglio cylinder 11. A wiping roller 15 for further removing excessive ink on the intaglio cylinder 11 abuts on a part of the intaglio cylinder 11 below the pre-wiping device 14 in a rotational direction of the intaglio cylinder 11. A part of this wiping roller 15 is soaked with a wiping solution stored in a wiping solution tank 16. Thereby, the wiping roller 15 is constantly washed.

A delivery cylinder 17 in the delivery unit 4 abuts on a part of the impression cylinder 10 at the lower side of the intaglio cylinder 11 in a rotational direction of the intaglio cylinder 11. A transport chain 19 is hung around the delivery cylinder 17. A large number of gripper devices 18 for receiving the paper sheets 100 from the impression cylinder 10 are attached to the transport chain 19 at predetermined intervals. The transport chain 19 travels, and circulates by being guided by an unillustrated chain guide. Thereby, the transport chain 19 transports the paper sheets 100 received from the impression cylinder 10, to pile boards 21a, 21b and 21c which are discharge locations. Each of the pile boards 21a, 21b and 21c is any one of a discharge location for the sheets of a specific kind, and a discharge location for remaining sheets. Specifically, each of the pile boards 21a, 21b and 21c is any one of the non-defective sheet (perfect sheet) discharge location, the single-group defective sheet discharge location, and the plural-group defective sheet discharge location in accordance with one of the sorting modes described later.

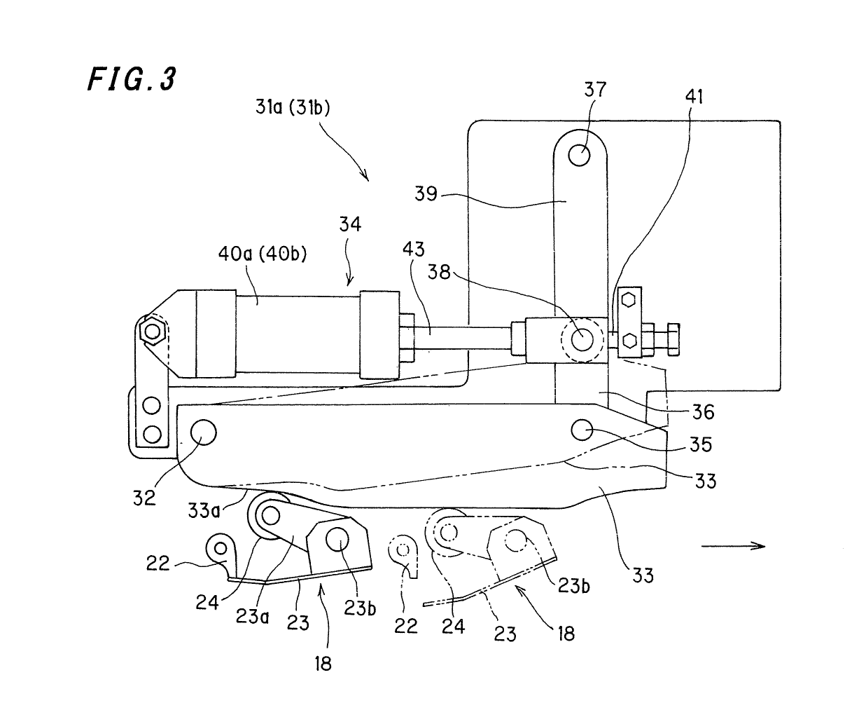

As shown in FIG. 3, each of the gripper devices 18 is formed of a gripper pad 22 and a gripper 23 which can open and close the gripper pad 22, and is configured to grip an edge of each of the paper sheets 100 by closing the gripper 23 to the gripper pad 22. The gripper 23 closes the gripper pad 22 by an elastic force urging the gripper 23. A roller-shaped cam follower 24 is attached to the gripper 23 via a lever 23a integrated with the gripper 23. By rotating this cam follower 24, the gripper 23 opens the gripper pad 22. Note that the gripper pad 22 and a shaft 23b of the gripper 23 are both attached to the transport chain 19.

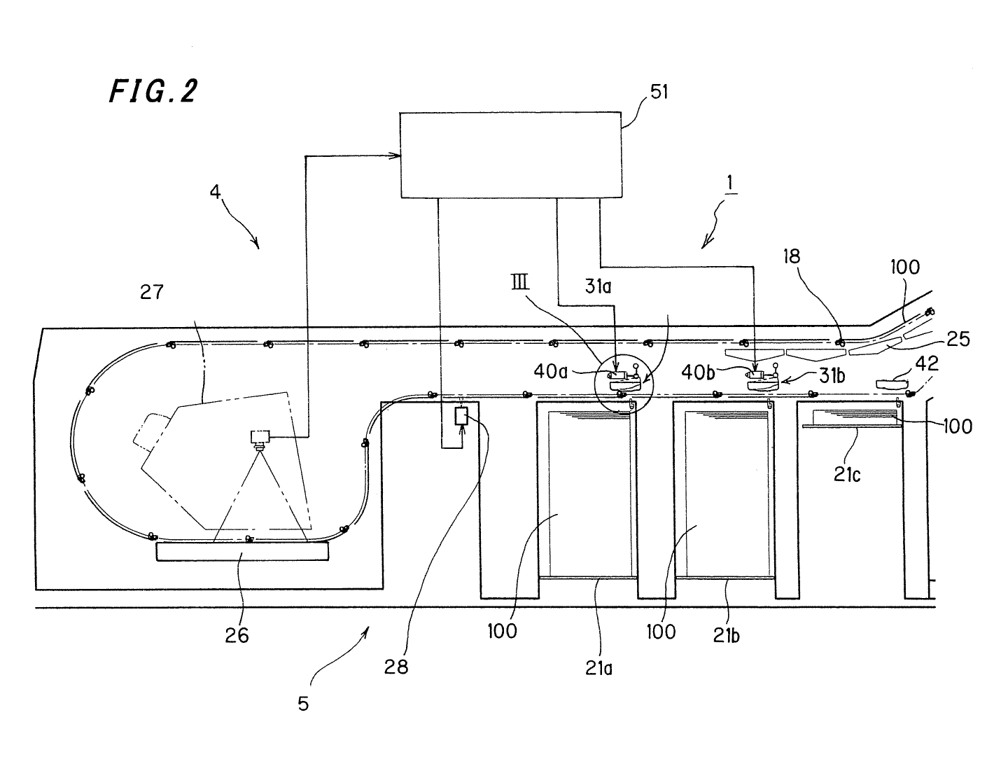

A circulation route of the transport chain 19 will be described below. As shown in FIGS. 1 and 2, the transport chain 19 is guided slightly upward from the delivery cylinder 17, passes through a horizontal portion, and is guided obliquely downward. Thereafter, the transport chain 19 again passes a horizontal portion, and curves to a large extent at the side opposite to the delivery cylinder 17. Subsequently, the transport chain 19 is guided substantially upward, passes over the pile boards 21a to 21c, and is guided obliquely upward. After that, the transport chain 19 passes through another horizontal portion, is guided slightly downward, and arrives back at the delivery cylinder 17.

As shown in FIG. 2, air ducts 25 for drying the printed paper sheets 100 are arranged under the transport chain 19 in a range between a sloping part at the upper side, and the horizontal portion next to the upper side, of the circulation route of the transport chain 19. The air ducts 25 are opened upward. The printed paper sheets 100 are dried by air caused to blow from the air ducts 25, against the paper sheets 100 in the course of being transported by the transport chain 19.

A suction table 26 is provided to the lower side in a location where the circulation route curves to a large extent at the side of the transport chain 19 opposite to the delivery cylinder 17. An unillustrated suction duct is connected to the suction table 26. Each of the paper sheets 100 transported by the transport chain 19 is sucked by the suction table 26. Thereby, sheets are not wrinkled, and are tense.

Over this suction table 26, that is, inside the part where the transport chain 19 curves, an inspection device 27 is provided in a way that the inspection device 27 faces the suction table 26. Conditions of patterns printed on each of the paper sheets 100 are detected by the inspection device 27. An optical and electronic photographing apparatus such as a CCD plane camera or a CCD line camera is adopted as the inspection device 27. The quality of the patterns is determined on the basis of images obtained by photographing the patterns by use of the photographing apparatus such as a CCD plane camera or a CCD line camera. It is needless to mention that the detection and the determination of whether a printing condition of a pattern is a non-defective or a defective are not limited to being performed by optical and electronic means, and that the detection and the determination may be performed by adopting any one of various means.

Marking devices 28 are provided to a part of the circulation route of the transport chain 19 in front of the pile board 21a located initially in a circulation direction of the circulation route of the transport chain 19. Each of the marking devices 28 places a mark (a discrimination mark) on a pattern determined to be defective by the inspection device 27. As the marking device 28, for example, an ink-jet printer, which performs marking by ejecting ink and the like, is adopted. It is needless to mention that a device of any kind may be adopted as long as the device is capable of placing a mark on the defective pattern. The marking devices 28 are provided in a way that the marking devices 28 correspond respectively to columns of patterns printed on each of the paper sheets 100. That is, five marking devices 28 are provided in a case where there are five columns of patterns in each of the paper sheets 100. These marking devices 28 may be formed integrally, or may be formed separately from one another.

Above the transport chain 19 over the first pile board 21a and the second pile board 21b, a first delivery cam device 31a and a second delivery cam device 31b are provided as discharge means. In accordance with a sorting mode as will be described later, each of the delivery cam devices 31a and 31b are provided as any one of the non-defective sheet discharge means, the single-group defective sheet discharge means, the plural-group defective sheet discharge means, as well as discharge means for sheets where a column with a defective pattern has not been identified. As shown in FIG. 3, each of the delivery cam devices 31a and 31b is provided to the main body part of the printing press along the circulation route of the transport chain 19. Each of the delivery cam devices 31a and 31b is formed of: a delivery cam 33 supported by a shaft 32 in a way that the delivery cam 33 can be turned vertically; and a cam driving device 34 which causes the delivery cam 33 to turn.

The cam driving device 34 is formed of a link 36, a link 39, and an air cylinder 40a (40b). The link 36 is linked to the side of the forefront of the delivery cam 33 via a shaft 35 in a way that the link 36 can be turned freely. A first end of the link 39 is supported at the side of the main body of the printing press by a shaft 37 so that the first end of the link 39 can be turned freely. A second end of the link 39 is linked to the link 36 with a shaft 38 so that the second end of the link 39 can be turned freely. A rod 43 is linked to the air cylinder 40a (40b). A forefront of the rod 43 is linked to the shaft 38 which is a linking portion of the links 36 and 39. The air cylinder 40a (40b) is supported by the main body part of the printing press.

As shown in FIG. 3, when the rod 43 of the air cylinder 40a (40b) extends, the links 36 and 39 together form a vertical straight line. Thereby, as indicated by the solid line in FIG. 3, the delivery cam 33 advances in a movement route of the cam follower 24 of the gripper device 18. When the rod 43 contracts by being driven by the air cylinder 40a (40b), the shaft 38, which connects the links 36 and 39 to each other, moves to the right in FIG. 3. Thereby, the links 36 and 39, which together form a straight line, are caused to be in a state of being bent. Accordingly, the delivery cam 33 turns upward as indicated by the two-dot chain line in FIG. 3, That is, the delivery cam 33 retreats from the movement route of the cam follower 24 of the gripper device 18 provided to the transport chain 19. Incidentally, in FIG. 3, reference numeral 41 indicates a stopper for maintaining the links 35 and 38 to be a vertical straight line.

When the delivery cam 33 is horizontal, the cam follower 24 of the gripper device 18 moves along a cam surface 33 of the delivery cam 33 with the movement of the conveyor chain 19. Thereby, the gripper 23 turns, and opens the gripper pad 22, as indicated by the solid line and the two-dot chain line in FIG. 3. That is, the paper sheet 100 gripped by the gripper device 18 is released (discharged). When the delivery cam 33 turns upward as the rod 43 is contracted by the operation of the air cylinder 40a (40b), the delivery cam 33 is retreated from the movement route of the cam follower 24. Thereby, the gripper 23 does not rotate. That is, the paper sheet 100 gripped by the gripper device 18 is not released.

A delivery cam 42 is provided as discharge means above the transport chain 19 over the pile board 21c located lastly in the circulation direction of the circulation route of the circulation route of the transport chain 19. Since the paper sheet 100 transported to the pile board 21c in the last place always needs to be discharged. For this reason, the discharge means is not subjected to choice of releasing or not releasing the paper sheet 100, but always releases the paper sheet 100. Hence, unlike the other delivery cams 33, the delivery cam 42 is fixed, and is not caused to turn. In accordance with any one of sorting modes described later, this delivery cam 42 is caused to be any one of: single-column defective discharge means, and discharge means for sheets where a column with a defective pattern has not been identified.

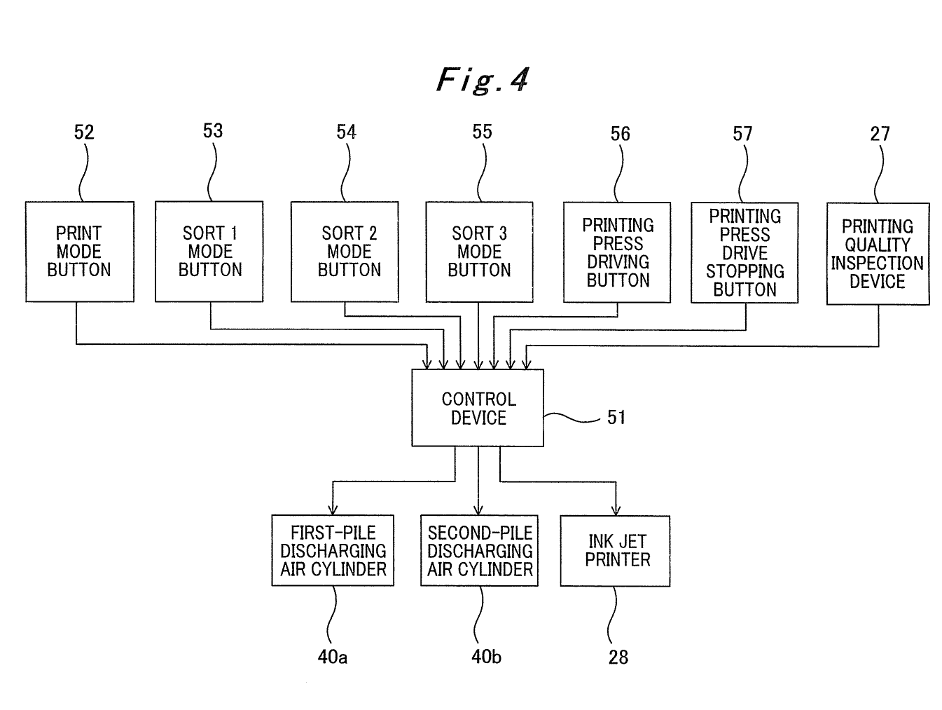

Next, on the basis of FIG. 4, descriptions will be provided for an outline of a control system, with which the printing press 1 is provided, and which performs sorting.

The printing press 1 is provided with a control device 51, and a program is installed in the control device 51. The program executes sorting methods described later. Thus, the control device 51 issues commands to each of the units in accordance with various inputs. As input means of the operation system to the control device 51, the printing press 1 is provided with a print-mode button 52, a Sort 1 button 53, a Sort 2 button 54, a Sort 3 button 55, a printing press driving button 56, and a printing press drive stopping button 57. Each of these buttons is arranged on an operation panel (illustration omitted) or the like of the printing press 1. By operating any one of these buttons, the printing press is subjected to a desired operation, and the program is executed.

A signal from the inspection device 27 is inputted to the control device 51. The control device 51 receives image-pickup signals for patterns from the inspection device 27, and determines whether each of the patterns is a non-defective or a defective. Thereafter, the control device 51 issues a drive signal to the marking device 28. Drive signals are issued to the air cylinder 40a of the delivery cam device 31a which is a first-pile discharging air cylinder, and to the air cylinder 40b of the delivery cam device 31b which is a second-pile discharging air cylinder.

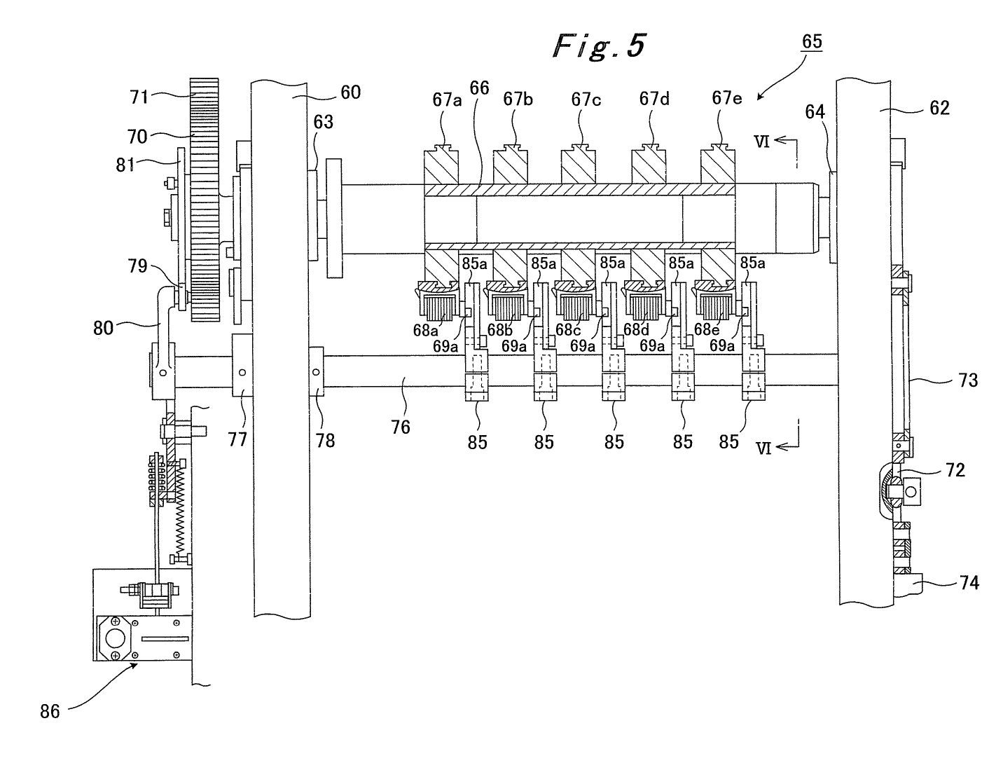

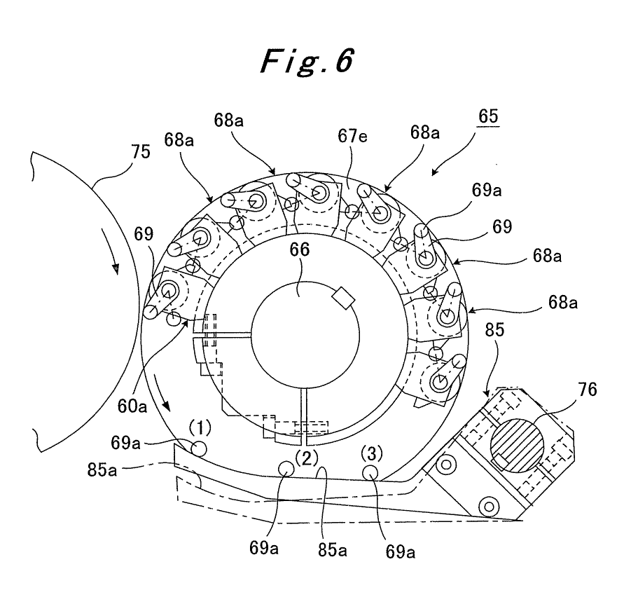

Subsequently, descriptions will be provided for the numbering and imprinting machine for printing numbers on patterns printed on sheets. The numbering and imprinting machine is shown in FIGS. 5 and 6.

A numbering cylinder 65 is supported with right and left frames 62 and 60 respectively via eccentric bearings 63 and 64 so that the numbering cylinder 65 can be turned freely. The numbering cylinder 65 is provided with a cylinder shaft 66 which is hollow; and numbering device mounting plates 67a, 67b, 67c, 67d and 67e which are located between the frames 60 and 62, and which are fixed to the cylinder shaft 66 by use of keys and split clamps. Each of eight numbering devices 68a, 68b, 68c, 68d, and 68e (hereinafter referred to as “68″ in a case where specification is not made for any one of the numbering devices) is mounted, at predetermined intervals, on a corresponding one of outer circumferential portions of the respective numbering device mounting plates 67a, 67b, 67c, 67d, and 67e. Each of the numbering devices 68a, 68b, 68c, 68d and 68e is configured to print numbers each having a predetermined number of digits, and is provided with the predetermined number of character rings each having relief printing plates respectively of figures from 0 to 9. When a lower order digit is carried to a higher order digit next to that lower digit, the character ring of the higher order digit rotates by a portion corresponding to one character. Rotation of the character ring for the lowest order digit is carried out by turning a number converting arm 69 projecting sideways from each of the numbering devices 68a to 68e. A wheel 69a is provided to an end portion of the number converting arm 69 in a way that the wheel 69a can be turned freely.

A cylinder gear 70 is attached to a portion of the cylinder shaft 66 which projects outward from the frame 60, and a gear 71 of a driving part is engaged with the cylinder gear 70. Accordingly, the numbering cylinder 65 is driven by the driving part via the gear 71 and the cylinder gear 70. The right and left eccentric bearings 64 and 63 project outward respectively of the frames 60 and 62. A first end of a link 73 is pivotally fitted to a lever 72, and a second end of the link 73 is pivotally fitted to projecting portions of the eccentric bearings 63 and 64. The lever 72 is pivotally fitted to an outer side of the frames 60 and 62. A lever 74 of a cam mechanism is linked to the other end of the lever 72, the lever 74 being provided to an outside surface of the frame 62. The lever 74 oscillated by the cam mechanism causes the eccentric bearings 63 and 64 to turn via the lever 72 and the link 73, Thereby, the cylinder of the numbering cylinder 65 is configured to be in engagement (contact) with, and in disengagement (separation) from, an impression cylinder 75 abutted oil by the numbering devices 68a to 68e.

A number conversion shaft 76 is supported in a vicinity of the numbering cylinder 65 in a way that the number conversion shaft 76 can be turned freely. The number conversion shaft 76 is supported between the right and left frames 60 and 62 respectively in a state where the movement of the number conversion shaft 76 in an axial direction is restricted by collars 77 and 78. A cam lever 80 provided with a cam follower 79 in an free end thereof is attached to an end of the number conversion shaft 76, the end projecting from the frame 60. Meanwhile, an oscillating cam 81, which includes a cam surface formed of a smaller-diameter portion and a larger-diameter portion, is fixed to the cylinder gear 70. The cam follower 79 is configured to abut on the cam surface of this oscillating cam 81. The cam lever 80 is urged by a spring force so that the cam follower 79 can be caused to constantly abut on the cam surface of the oscillating cam 81.

Furthermore, on the number conversion shaft 76, number conversion members 85 each having a circular-arc engagement surface 85a are fixed by means of keys, split clamps and the like. The number conversion members 85 correspond to the respective numbering device mounting plates 67a to 67e. The number conversion members 85 oscillate, along with the cam lever 80, between positions respectively indicated by the solid line, and by a one-dot chain line in FIG. 6.

When the cam follower 79 corresponds to the smaller-diameter portion of the oscillating cam 81, the number conversion member 85 is located in the position indicated by the solid line in FIG. 6. In this event, when the numbering device 68 which revolves together with the numbering cylinder 65 passes the engagement surface 85a, a number of the numbering device 68 is converted. That is, the engagement surface 85a of the number conversion member 85 advances into a position where the engagement surface 85a is engaged with the wheel 69a. Thereby, the wheel 69a of the number converting arm 69 of the numbering device 68 moves along a track indicated by (1), (2) and (3) in FIG. 6, and the wheel 69a is engaged with the engagement surface 85a. The wheel 69a is then pressed by the engagement surface 85a. Accordingly, the number converting arm 69 is caused to turn, and an applicable one of the character rings of the numbering device 68 rotates by a portion corresponding to one character. Thus, the number is converted.

When a position of the cam follower 79 corresponds to the larger-diameter portion of the oscillating cam 81, and is located in a position indicated by the one-dot chain line in FIG. 6, the wheel 69a at the end of the number converting arm 69 is not in contact with the engagement surface 85a of the number conversion member 85. Accordingly, the number is not converted even when the numbering device 68 rotates.

Note that a circumferential angle and a phase of the cam surface of the oscillating cam 81 is set for the following purposes. First, at the time when the numbering device 68 foremost among all of the numbering devices 68 in a rotation direction of the numbering cylinder 65 corresponds to the engagement surface 85a of the number conversion member 85, the engagement surface 85a can be moved (advance) from a position indicated by the one-dot chain line to a position indicated by the solid line. Second, at the time when the numbering device 68 rearmost among them has finished passing the engagement surface 85a, the engagement surface 85a can be moved (retreat) from the position indicated by the solid line to the position indicated by the one-dot chain line. The cam lever 80 is provided with a number conversion control device 86 for permitting, and for regulating, the oscillation of the cam lever 80. That is, the configuration is that in which it is made possible to avoid the conversion of numbers of the numbering devices 68 even when the oscillating cam 81 rotates.

The following components are omitted in FIGS. 5 and 6. The numbering and imprinting machine is provided with a feeder for feeding one paper sheet at a time to an interstice between the numbering cylinder 65 and the impression cylinder 75; and a delivery unit formed of such components as a chain for gripping and delivering sheets which have passed through the interstice between the numbering cylinder 65 and the impression cylinder 75, and which thus have numbers printed thereon.

The air cylinders are adopted as driving sources for the respective units in the configuration of the apparatus described above with reference to FIGS. 1 to 6. However, it is obvious that a hydraulic cylinder, a motor or the like can be adopted as the driving source.

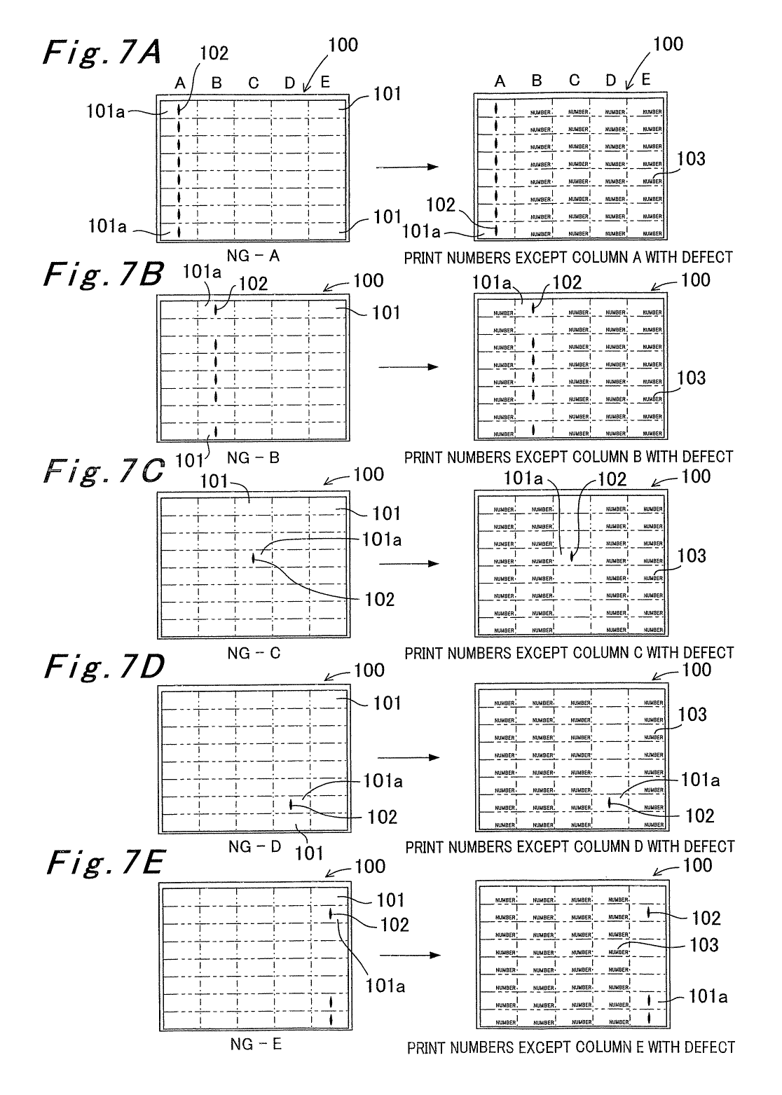

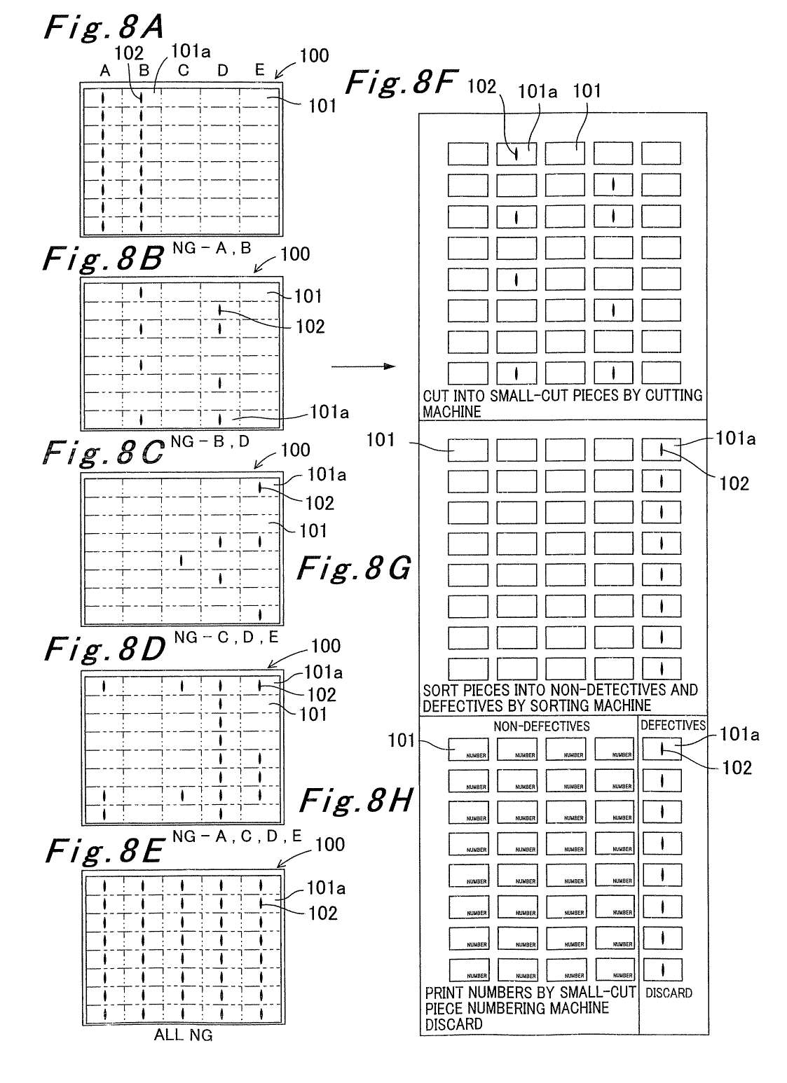

The configuration of the apparatus has been described hereinabove. Subsequently, on the basis of FIG. 7 and FIGS. 8A to 8H, descriptions will be provided for one example of the sorting method carried out by the above apparatus.

On each of the paper sheets 100, patterns 101, which are bank notes, securities or the like, are printed in 5 longitudinally extending lines (5 columns), and in 8 laterally extending lines (8 rows). The columns are referred to as Column A, Column B, Column C, Column D and Column E from left to right. Sorting is carried out by grouping the patterns 101 on each of the paper sheets 100, and then by determining whether or not defective patterns exist in each of the groups. The following methods can be considered as methods of grouping the patterns. Such methods include setting each of the longitudinal columns (columns A to E) as a group; setting each of the lateral rows as a group; and setting a block of a predetermined number of the patterns 101 extending over the plurality of columns or rows. Here, an example where each of the longitudinal columns (Columns A to E) is set as a group (5 groups per sheet) will be described. That is, as shown in the left-hand side of FIG. 7, determination is made whether or not each of Columns A to E has a defective pattern. In embodiments shown below, sheets each having no defect are defined as the sheets of the specific kind. Other sheets, that is, sheets each with a defect in any one of groups thereof, and sheets each with defects in patterns in more than one group are defined as the remaining sheets.

Sheets are sorted into non-defective sheets (perfect sheets), single-group defective sheets and plural-group defective sheets. The non-defective sheet is a sheet which does not have any defective pattern, the single-group defective sheet is a sheet which has at least one defective pattern only in one of the plurality of groups, and the plural-group defective sheet is a sheet which has defective patterns in each of at least two groups of the plurality of groups.

Note that a case where at least one of the patterns 101 in Column A is a defective will be denoted as NG-A. Similarly, as to the rest of the columns, cases where at least one of the patterns 101 in the rest of the columns is a defective are respectively referred to as NG-B, NG-C, NG-D and NG-E. Whether the pattern is a non-defective or a defective is detected by the aforementioned inspection device 27, and is determined by the control device 51. A discrimination mark 102 is placed, by a marking device 28, on a pattern (defective pattern) 101a determined to be a defective.

A number (which may include not only a figure but also an alphabet and any other symbol) 103 is printed on each of the patterns 101 of the paper sheets 100 by the numbering and imprinting machine. However, in a case where any one of the columns has a defect in at least one of the patterns 101, number printing is carried out, as shown in the right-hand side of FIG. 7, on the columns except the column with the pattern (a defective pattern) which is a defective. That is, in a case where the numbering and imprinting machine is that capable of printing numbers in the five columns, number printing is not caused to function on the column with the defective pattern. Even in a case where patterns with no defects are included in a column with the pattern 101a determined to be defective, number printing on this column is not carried out at this stage.

FIG. 8 shows a sorting process in a case where there are defects (defective patterns) in the patterns in the plurality of columns. The left-hand side of FIG. 8 shows cases in each of which there are defects in the plurality of columns in the paper sheet 100. The case where there are defects in Columns A and B is denoted as NG-A, B. Likewise, in accordance with the columns with defects, other cases are denoted as NG-B,D, NG-C,D,E, and NG-A,C,D,E, and the like. The case where all of the patterns in all of the columns are defectives are denoted as ALL NG. As in the above cases, in a case where the defective patterns 101a exist in the patterns 101 in the plurality of columns in the paper sheet 100, the paper sheet 100 is first cut into small-cut pieces (a size of one piece of bank note, or of security, i.e., a size of one piece of pattern) by a cutting machine. Then, each of the patterns (small-cut piece printed products) 101 is individually determined as a non-defective or a defective, and is sorted as determined. Thereafter, number printing is carried out individually on each of the small-cut piece printed products 101. The defectives are disposed, or reused. Incidentally, when there is at least one of the columns with no defect, it is also possible to carry out number printing on this column by causing a numbering and imprinting machine corresponding to paper sheets (corresponding to large-sized paper sheets) to function on that one column.

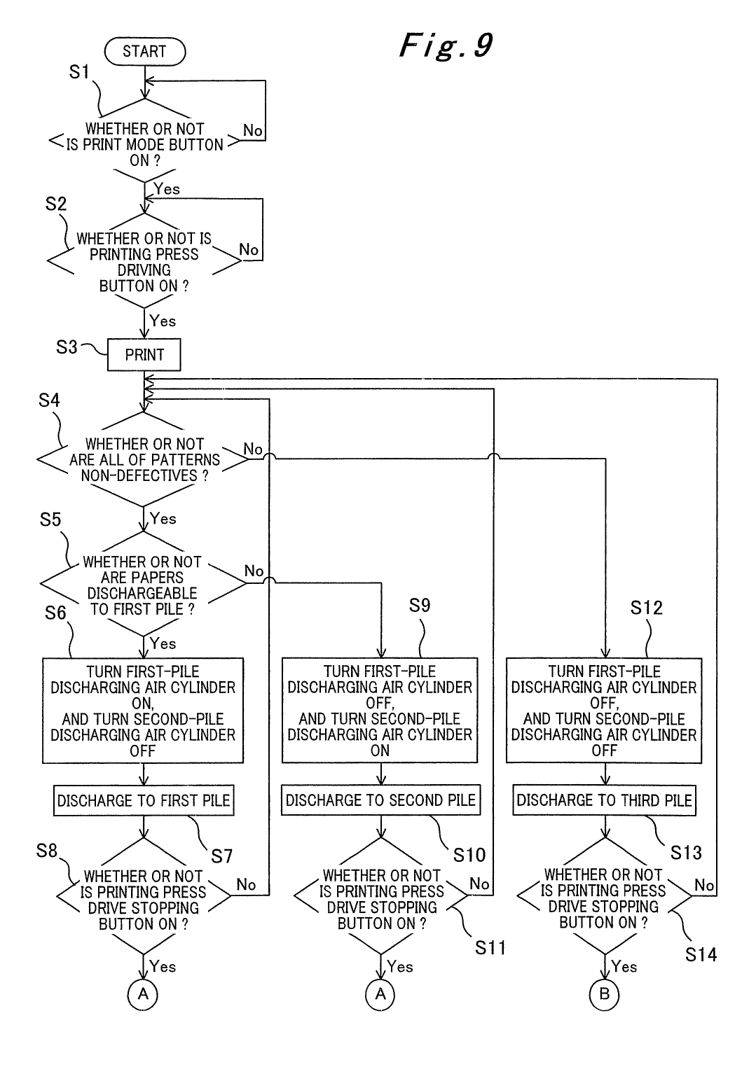

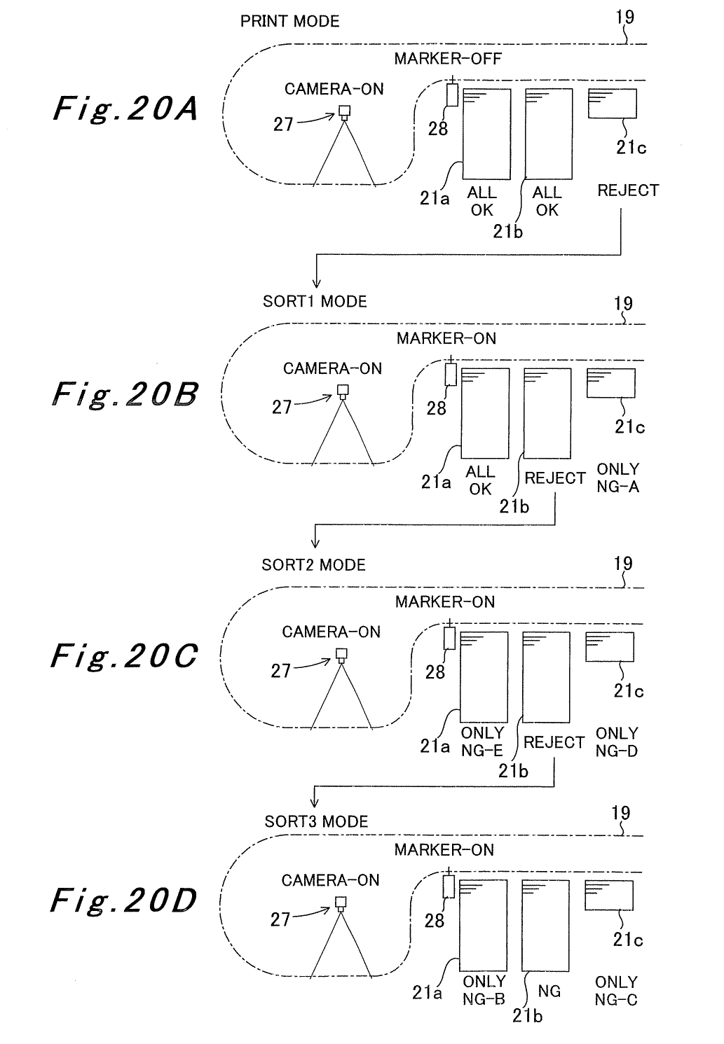

Next, specific contents of the sorting methods will be described on the basis of flowcharts of FIGS. 9 to 19, and with reference to FIGS. 7 and 8 described above, and to FIG. 20.

<Print Mode>

First of all, a print mode will be described on the basis of FIGS. 1 to 6 and FIG. 9. In order to execute the print mode, the print mode button 52 and the printing press driving button 56 which are arranged on an operation panel and the like are turned ON. Accordingly, the control device 51 of the printing press 1 initially determines whether or not the print mode button 52 is ON (step S1). In a case where the print mode button 52 is not ON, the determination in step S1 is repeated until it is ON.

When the print mode button 52 is ON, determination is made in step S2 as to whether or not the printing press driving button 56 is ON. When it is determined that the printing press driving button 56 is ON, printing is executed (step S3). That is, in FIG. 1, printing is performed, in the printing unit 3, on the paper sheet 100 sent by the paper feeding device 6 of the feeder 2. The paper sheets 100 fed by the paper feeding device 6 are transferred to the impression cylinder 10 via the transfer cylinders 8 and 9. On the other hand, the inking devices 13 supply ink to the chablon rollers 12, and the chablon rollers 12 supply the ink to the predetermined locations of the intaglio cylinder 11. Excessive ink on the intaglio cylinder 11 is removed by the pre-wiping device 14 and the wiping roller 15. By pressing, against the intaglio cylinder 11, the paper sheet 100 transferred to the impression cylinder 10, ink on the intaglio cylinder 11 is transferred onto the paper sheet 100. Thereby, the patterns are printed on the paper sheet 100.

After the paper sheet 100 with patterns printed thereon is transferred to the delivery cylinder 17 from the impression cylinder 10, the paper sheet 100 undergoes gripping change between the gripper devices 18 provided to the transport chain 19. Subsequently, the transport chain 19 travels along the chain guide. Thereby, each of the paper sheets 100 is transported toward a location where the inspection device 27 is provided.

A printing condition of the paper sheet 100 is detected in the inspection device 27. When the inspection device 27 is that using an optical and electronic photographing apparatus such as a CCD camera, patterns on the paper sheet 100 are photographed, detection signals, which are results of the photographing, are transmitted to the control device 15, and each of the patterns 101 on the paper sheet 100 is determined to be a non-defective or a defective (step S4).

In a case where it is determined that all of the patterns on the paper sheet 100 are non-defectives (YES), whether or not the paper sheet 100 can be discharged to the first pile board 21a (“dischargeable to a first pile”) is subsequently determined (step S5). The above determination as this is made because no more delivery can be made to the first pile board 21a when the first pile board 21a is full.

When it is determined that the paper sheet 100 can be discharged to the first pile board 21a (YES), the air cylinder (a first-pile discharging air cylinder) 40a in the first delivery cam device 31a is turned ON, and the air cylinder (a second-pile discharging air cylinder) 40b in the second delivery cam device 31b for making delivery to the second pile board 21b is turned OFF (step S6). That is, the delivery cam 33 of the first delivery cam device 31a is moved into an advanced position indicated by the solid line in FIG. 3. The delivery cam 33 of the second delivery cam device 31b is moved into a retreated position indicated by the two-dot chain line in FIG. 3.

The cam follower 24 of the gripper device 18 moves along the cam surface 33a of the delivery cam 33. Thereby, the paper sheet 100 is gripped by the gripper pad 22 and the gripper 23 is discharged (is subjected to first-pile discharge) onto the first pile board 2 la (step S7).

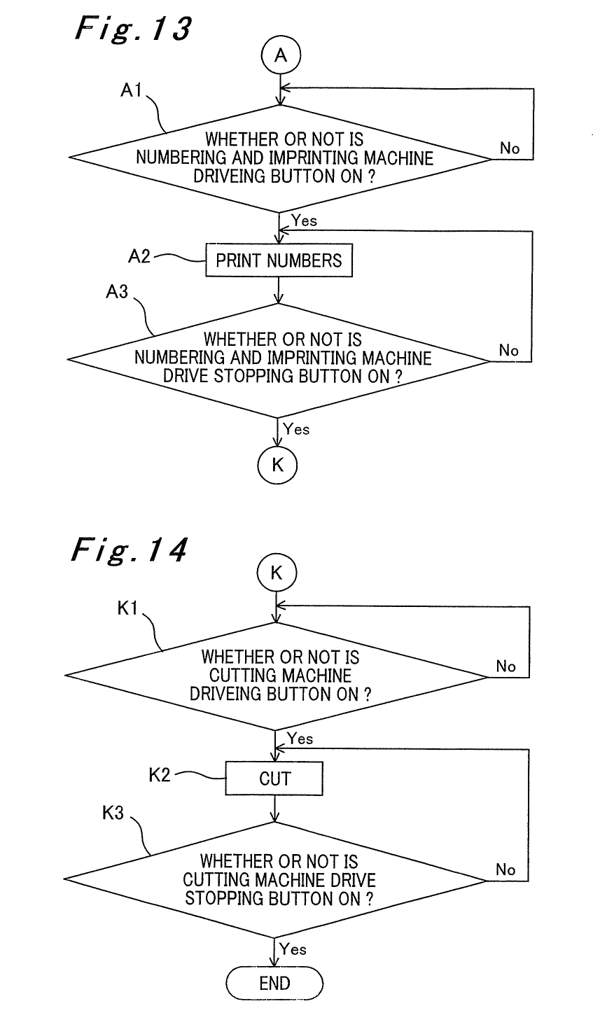

Subsequently, determination is made whether or not the printing press drive stopping button 57 is ON (step S8). When it is determined that it is ON (YES), it means that printing has been stopped. Consequently, the flow proceeds to subsequent steps (Routine A shown in FIG. 13) for number printing. In a case where it is determined that the printing press drive stopping button 57 is not ON (NO), it means that printing is continued. Consequently, the flow returns to step S4. Accordingly, a series of steps for determining whether or not the paper sheet 100 sent in next is a non-defective, and where this paper sheet 100 is discharged, is repeated.

Determination is made whether or not the paper sheet 100 can be discharged to the first pile board 21a in step S5. In a case where it is determined as “NO” in step S5, the delivery of the paper sheet 100 to the first pile board 21a (the first pile) is not made, and the paper sheet 100 is caused to be delivered to the second pile board 21b. That is, in step S9, the air cylinder (first-pile discharging air cylinder) 40a in the first delivery cam device 31a is turned OFF, and the air cylinder (second-pile discharging air cylinder) 40b in the second delivery cam device 31b for performing delivery to the second pile board 21b is turned ON.

The delivery cam 33 of the first delivery cam device 31a is moved into the retreated position indicated by the two-dot chain line in FIG. 3. The delivery cam 33 of the second delivery cam device 31b is moved into the advanced position indicated by the solid line in FIG. 3. In the first delivery cam device 31a, since the delivery cam 33 has retreated, the cam follower 24 and the delivery cam 33 are not engaged with each other. Thereby, the gripper 23 is not opened, and the paper sheet 100 is not discharged onto the first pile board 21a. In the second delivery cam device 31b, since the delivery cam 33 has advanced into the movement route of the cam follower 24, the cam follower 24 of the gripper device 18 moves along the cam surface 33a of the delivery cam 33, and thus the gripper 23 opens. Thereby, the paper sheet 100 gripped by the gripper pad 22 and the gripper 23 is discharged (is subjected to second-pile discharge) onto the second pile board 21b (step S10).

Subsequently, whether or not the printing press drive stopping button 57 is ON is determined (step S11). When it is determined that it is ON (YES), it means that printing has been stopped. Consequently, the flow proceeds to subsequent steps (Routine A shown in FIG. 13) for number printing. In a case where it is determined that the printing press drive stopping button 57 is not ON (NO), it means that printing is continued. Consequently, the flow returns to step S4. Accordingly, a series of steps for determining whether or not the paper sheet 100 sent next is a non-defective, and where this paper sheet 100 is discharged, is repeated.

In a case where it is determined in step S4 that “all of the patterns are non-defectives” is false (NO), i.e., that at least any one of the patterns is a defective, the flow proceeds to step S12, and the paper sheet 100 is discharged to the third pile board 21c. In step S12, the air cylinders (the first-pile and second-pile discharging air cylinders) 40a and 40b respectively in the first and second delivery cam devices 31a and 31b are both turned OFF, and the delivery cams 33 of the first and second delivery cam devices 31a and 31b are caused to retreat from the movement route of the cam follower 24 of the gripper device 18. Accordingly, the gripper device 18 passes by the first and second pile boards 21a and 21b, and reaches the delivery cam 42 which is located and fixed to a position over the third pile board 21c. The cam follower 24 of the gripper device 18 is engaged with the delivery cam 42, and the gripper 23 opens the gripper pad 23. Thereby, the paper sheet 100 is discharged (is subjected to third-pile discharge) onto the third pile board 21c (step S13).

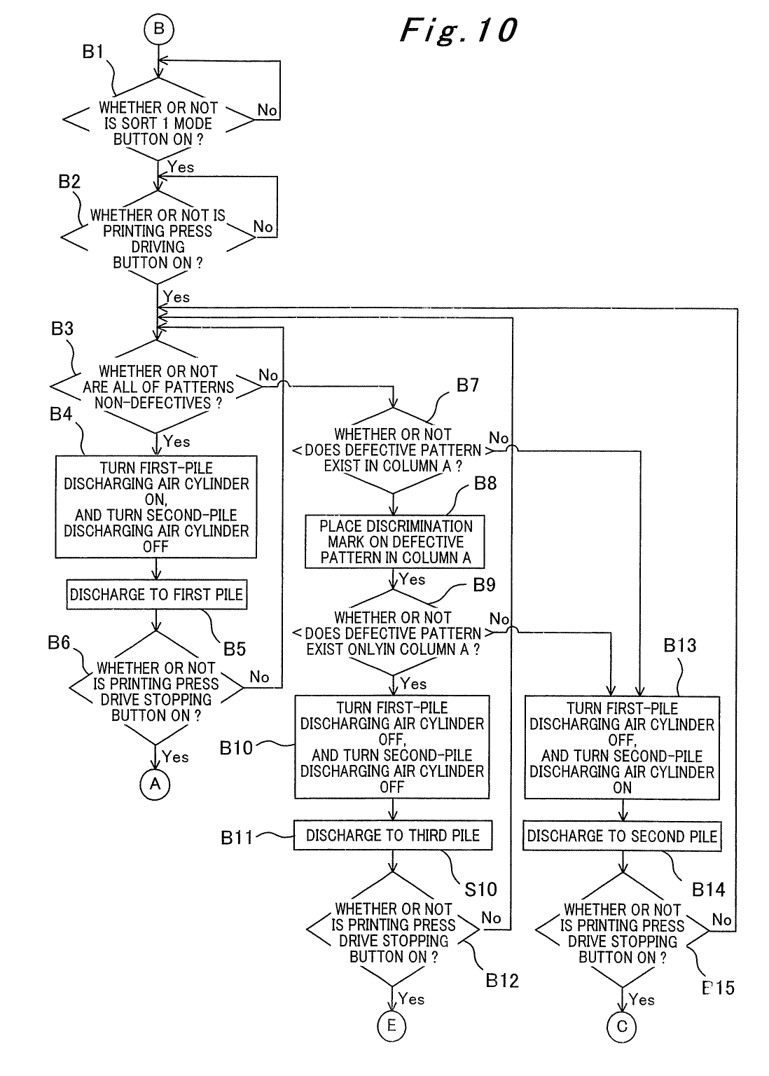

Subsequently, whether or not the printing press drive stopping button 57 is ON is determined (step S14). When it is determined that it is ON (YES), it means that printing has been stopped. Consequently, the flow proceeds to subsequent steps (Routine B shown in FIG. 10) for further sorting the paper sheets 100 including the defective patterns. In a case where it is determined that the printing press drive stopping button 57 is not ON, it means that printing is continued. Consequently, the flow returns to step S4. Accordingly, a series of steps for determining whether or not the paper sheet 100 sent next is a non-defective, and where this paper sheet 100 is discharged, is repeated.

FIG. 20A schematically expresses a condition of the aforementioned print mode. The paper sheets 100, in which all of the patterns are non-defectives, are accumulated on the first and second pile boards 21a and 21b, and the paper sheets 100, in which at least any one of the patterns are defective, are accumulated on the third pile board 21c. Thus, the first and second pile boards 21a and 21b are used as locations where the non-defective are discharged, and the first and second delivery cam devices 31a and 31b are the non-defective sheet discharge means.

<Sort 1 Mode>

Next, a Sort 1 mode will be described on the basis of FIG. 10.

The Sort 1 mode is a mode for further sorting the paper sheets 100, which are accumulated on the third pile board 21c in the print mode, and which are determined to have at least any one pattern therein being defective. This mode is carried out after a certain number of paper sheets 100 of this kind are piled up. First, the paper sheets 100 of this kind are set in the feeder 2 of the printing press 1. Subsequently, the Sort 1 mode button 53 on the operation panel or the like is turned ON, and the printing press driving button 56 is concurrently turned ON. Incidentally, before executing the Sort 1 mode, all of the pile boards 21a, 21b and 21c in the delivery unit 4 are empty. The paper sheets 100 which are accumulated on the first and second pile boards 21a and 21b, and which are non-defectives, are caused to undergo the subsequent number printing steps as described above.

In the control system, whether or not the Sort 1 mode button 53 is ON is initially determined (step B1). When it is determined that the Sort 1 mode button 53 is not ON (NO), this determination is repeated until the Sort 1 mode button 53 is ON.

When it is determined that the Sort 1 mode button 53 is ON, whether or not the printing press driving button 56 is ON is subsequently determined (step B2). When it is determined that the printing press driving button 56 is not ON (NO), this determination is repeated until the printing press driving button 56 is ON.

When the Sort 1 mode button 53 is ON, and when the printing press driving button 56 is also ON, the paper sheets 100 set in the feeder 2 of the printing press 1 are sent out one by one by the paper feeding device 6. In this Sort 1 mode, printing by the printing unit 3 is not carried out. Instead, each of the paper sheets 100 passes by the printing unit 3, and reaches the delivery unit 4. After that, the paper sheet 100 is transported by the transport chain 19 in the similar manner to that described in the case with the print mode.

Whether or not all of the patterns on the paper sheet 100 are non-defectives is determined (step B3). Whether or not all of the patterns on this paper sheet 100 are non-defectives has been determined in the print mode. However, the above determination is made again. As in the case with the corresponding determination in the printing mode, this determination is made in the control device 51 on the basis of a result of inspection by the inspection device 27.

When it is determined that all of the patterns on the paper sheet 100 are non-defectives (YES), the paper sheet 100 of this kind is discharged to the first pile board 21a. That is, the air cylinder (the first-pile discharging air cylinder) 40a in the first delivery cam device 31a above the first pile board 2 la is turned ON. Moreover, the cam follower 24 is engaged with the delivery cam 33 and thus the gripper 23 opens. Thereby, the paper sheet 100 is discharged (is subjected to first-pile discharge) onto the first pile board 21a (step S7). The air cylinder (the second-pile discharging air cylinder) 40b in the second delivery cam device 31b is turned OFF.

Subsequently, whether or not the printing press drive stopping button 57 is ON is determined (step B6). When it is determined that it is ON (YES), it means that printing has been stopped. Consequently, the flow proceeds to subsequent steps (Routine A shown in FIG. 13) for number printing. When it is determined that the printing press drive stopping button 57 is not ON (NO), it means that printing is continued. Consequently, the flow returns to step B3. Thereby, a series of steps for determining whether or not the paper sheet 100 sent next is a non-defective is repeated.

In a case where it is determined in step B3 that “all of the patterns are non-defectives” is false (NO), i.e., that at least any one of these patterns is a defective, the flow proceeds to step B7, and whether or not a defective exists in the patterns in Column A is determined. In a case where a defective exists in at least one of the patterns in Column A, it is determined that “a defective exists in Column A” (YES).

When defect is thus detected, a drive signal is issued by the control device 51 to the marking device 28. Thereby, by use of ink, a discrimination mark 102 (refer to FIG. 7) is placed onto the defective pattern 101a existing in Column A (Step B8).

Subsequently, determination is made whether or not the paper sheet 100 with the defective pattern is a single-column defective sheet (the single-group defective sheet). That is, determination is made whether or not a defective pattern exists only in Column A (step B9). Cases where a defective pattern exists only in Column A include not only a case where all of the patterns in Column A are defective as shown in FIG. 7, but also cases where at least one of the patterns in Column A has a defect.

In a case where any defective exists only among the patterns in Column A, this paper sheet 100 is sorted out as the single-column defective sheet (the single-group defective sheet). This sorting is carried out by causing this paper sheet 100 to be discharged only onto the third pile board 21c. That is, the air cylinders (the first-pile and second-pile discharging air cylinders) 40a and 40b respectively in the first and second delivery cam devices 31a and 31b are both turned OFF (step B10). By setting the air cylinders 40a and 40b in the respective first and second delivery cam devices 31a and 31b to be both OFF, the delivery cams 33 are prevented from contributing to operations for opening the gripper 23 of the gripper device 18. Accordingly, the gripper 23 does not open over the first and second pile boards 21a and 21b, but opens by being engaged with the delivery cam 42 which is located and fixed to a position over the third pile board 21c. Thereby, the paper sheet 100 is discharged (is subjected to third-pile discharge) onto the third pile board 21c (step B11).

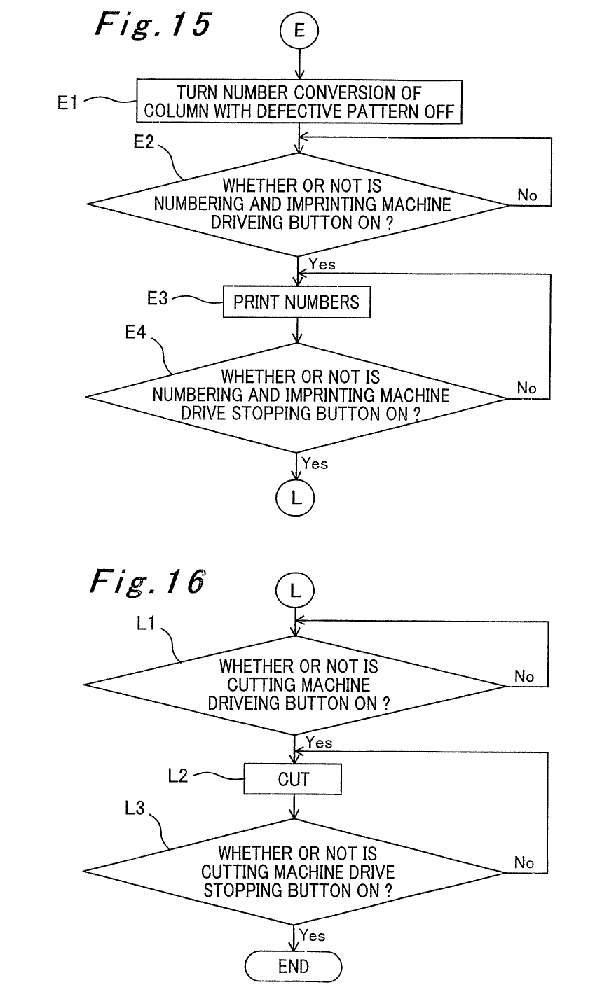

Subsequently, whether or not the printing press drive stopping button 57 is ON is determined (step B12). Unless the printing press drive stopping button 57 is turned ON, printing is continued. Consequently, the flow returns to step B3. Accordingly, the sorting of the paper sheet 100 to be sent in next is carried out. When the printing press drive stopping button 57 is turned ON, the flow proceeds to steps (Routine E shown in FIG. 15) for printing numbers on the single-column defective sheets.

In a case where it is determined in step B7 that “a defective pattern exists in Column A” is false (NO), i.e., that any defect exists in the columns other than Column A (regardless of whether the defect exists only in a single, or in the plurality of columns), the paper sheet 100 is discharged to the second pile board 21b in preparation for subsequent sorting. That is, the air cylinder (the first-pile discharging air cylinder) 40a in the first delivery cam device 31a is turned OFF, and the air cylinder (the second-pile discharging air cylinder) 40b in the second delivery cam device 31b is turned ON (step B13).

The paper sheet 100 is not discharged to the first pile board 21a, and is caused to be discharged (to be subjected to second-pile discharge) only onto the second pile board 21b (step B14).

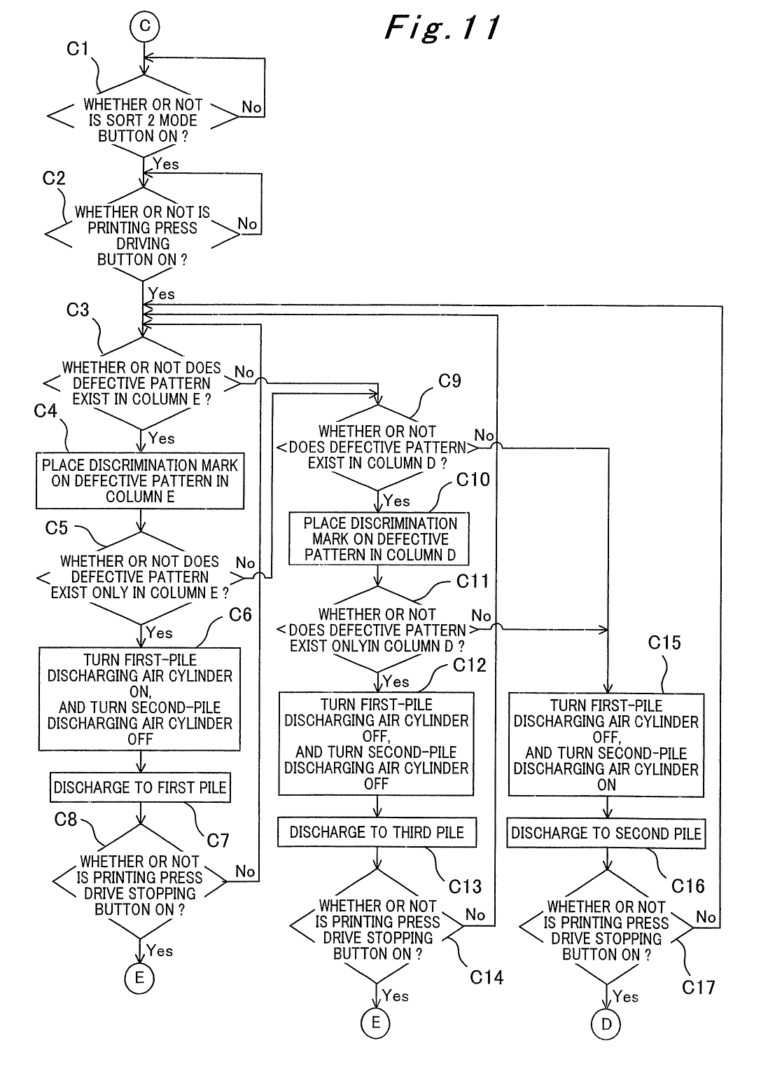

Subsequently, whether or not the printing press drive stopping button 57 has been turned ON is determined (step B15). Unless the printing press drive stopping button 57 is turned ON, printing is continued. Consequently, the flow returns to step B3. Thereby, the sorting of the paper sheet 100 to be sent in next is carried out. When the printing press drive stopping button 57 is turned ON, the flow proceeds to steps (Routine C shown in FIG. 11) for further sorting (Sort 2) the paper sheet 100.

When it is determined in step B9 that “a defective pattern exists only in Column A” is false, the paper sheet 100 of this kind has a defect also in the patterns in the columns other than Column A. Consequently, the flow proceeds to step B13, and the paper sheet 100 is discharged onto the second pile board 21b for further sorting (Sort 2) the paper sheet 100.

As has been described above, in the Sort 1 mode, the paper sheets 100 with a defective only among the patterns in Column A are sorted out from the other paper sheets, and are accumulated on the third pile board 21c. The other sheets, that is, the sheets with a defect among the patterns in a single column other than Column A, and the sheets with a defect among the patterns in the plurality of columns, are accumulated on the first pile board 21a. FIG. 20B schematically expresses the condition of this flow. In the Sort 1 mode, the first pile board 21a is used as a location where the non-defectives are discharged, and the first delivery cam device 31a corresponding to the first pile board 21a is the non-defective sheet discharge means. The third pile board 21c is used as a location where the single-group (Column A) defective sheets are discharged, and the fixed delivery cam 42 is the single-group defective sheet discharge means.

<Sort 2 Mode>

Next, a Sort 2 mode will be described on the basis of FIG. 11. The Sort 2 mode is a mode for further sorting the sheets, which have been accumulated on the second pile board 21b in the print mode, which include those with a defect among the patterns in a single column other than Column A, and which include those with a defect among the patterns in the plurality of columns. In order to execute this operation the paper sheets 100 accumulated on the second pile board 21b in the Sort 1 mode are set in the feeder 2 of the printing press 1. Subsequently, the Sort 2 mode button 54 on the operation panel or the like is turned ON, and the printing press driving button 56 is concurrently turned ON. Incidentally, in the printing press 1, all of the pile boards 21a, 21b and 21c in the delivery unit 4 are empty. The non-defective sheets and the sheets with a defective only among the patterns in Column A are caused to undergo subsequent processes, or are held to stand by for a subsequent process.

First, whether or not the Sort 2 mode button 54 is ON is determined (step C1). When it is determined that the Sort 2 mode button 54 is not ON (NO), this determination is repeated until the Sort 2 mode button 54 is ON.

When it is determined that the Sort 2 mode button 54 is ON, whether or not the printing press driving button 56 is ON is subsequently determined (step C2). When it is determined that the printing press driving button 56 is not ON (NO), this determination is repeated until the printing press driving button 56 is ON.

When the Sort 2 mode button 54 is on, and when the printing press driving button 56 is also ON, the paper sheets 100 set in the feeder 2 of the printing press 1 are sent out one by one by the paper feeding device 6. In this Sort 2 mode the printing unit 3 does not function as in the case with the Sort 1 mode. Each of the paper sheets 100 passes by the printing unit 3, and thus reaches the delivery unit 4. Thereafter, the paper sheets 100 are transported by the transport chain 19 in the same manner as described in the case with the print mode.

Subsequently, determination is made whether or not the paper sheet 100 with a defective pattern is that with a defective among the patterns in Column E (step C3). In a case where there is a defective in at least one of the patterns in Column E, it is determined that “a defective exists in Column E” (YES).

When it is detected that a defect exists in the patterns in Column E, a drive signal is issued to the marking device 28 by the control device 51. Thereby, by use of ink, the discrimination mark 102 (refer to FIG. 7) is placed onto the defective pattern 101a existing in Column E (Step C4).

Subsequently, determination is made whether or not this paper sheet 100 with a defective pattern is the single-column defective sheet (the single-group defective sheet). That is, determination is made whether or not a defective pattern exists only among the patterns in Column E (step C5). Cases where a defective pattern exists only among the patterns in Column E include not only a case where all of the patterns in Column E are defectives, but also cases where at least one of the patterns in Column E is the defective pattern 101a as shown in FIG. 7.

In a case where a defective exists only among the patterns in Column E, this sheet is sorted out as the single-column defective sheet. This sorting is carried out by causing this paper sheet 100 to be discharged only onto the first pile board 21a. That is, the air cylinder (the first-pile discharging air cylinder) 40a in the first delivery cam device 31a is turned ON (step C6). The air cylinder (the second-pile discharging air cylinder) 40b in the second delivery cam device 3 lb for performing delivery to the second pile board 21b is turned OFF.

By turning the air cylinder 40a in the first delivery cam device 31a ON, the cam follower 24 of the gripper 23 of the gripper device 18 is engaged with the delivery cam 33. Thus, the gripper 23 opens, and the paper sheet 100 is discharged (is subjected to first-pile discharge) onto the first pile board 21a (step C7).

Subsequently, whether or not the printing press drive stopping button 57 is ON is determined (step C8). Unless the printing press drive stopping button 57 is turned ON, printing is continued. Consequently, the flow returns to step C3, and the sorting of the paper sheet 100 to be sent in next is carried out. When the printing press drive stopping button 57 is turned ON, the flow proceeds to steps (Routine E shown in FIG. 15) for printing numbers on the single-column defective sheets.

With respect to the paper sheet 100 for which it is determined in step C3 that a defective pattern exists in Column E” is false (NO), i.e., that a defective exists in the patterns in columns other than Column E (regardless of whether the defective exists in a single column or in the plurality of columns), determination is made whether or not a defective exists in the patterns in Column D (step C9).

When it is determined that a defective exists in Column D (YES), a drive signal is issued to the marking device 28 by the control device 51. Thereby, by use of ink, the discrimination mark 102 (refer to FIG. 7) is placed onto the defective pattern 101a existing in Column D (Step C10).

Subsequently, determination is made whether or not this paper sheet 100 with a defective pattern is the single-column defective sheet (the single-group defective sheet). That is, determination is made whether or not a defective pattern exists only among the patterns in Column D (step C11). Cases where a defective pattern exists only among the patterns in Column D includes not only a case where all of the patterns in Column D are defectives, but also cases where at least one of the patterns in Column D is the defective pattern 101a as shown in FIG. 7.

In a case where a defective exists only among the patterns in Column D, this sheet is sorted out as the single-column defective sheet (the single-group defective sheet). This sorting is carried out by causing this paper sheet 100 to be discharged only onto the third pile board 21c. That is, the air cylinders (the first-pile and second-pile discharging air cylinders) 40a and 40b in the respective first and second delivery cam devices 31a and 31b are both turned OFF (step C12).

By turning both of the air cylinders 40a and 40b in the respective first and second delivery cam devices 31a and 31b OFF, the delivery cams 33 are prevented from contributing to operations of opening the gripper 23 of the gripper device 18. Hence, the gripper 23 does not open over the first and second pile boards 21a and 21b. Instead, the gripper 23 opens by being engaged with the fixed delivery cam 42 located over the third pile board 21c. Thereby, the paper sheet 100 is discharged (is subjected to third-pile discharge) onto the third pile board 21c (step C13).

Subsequently, whether or not the printing press drive stopping button 57 is ON is determined (step C14). Unless the printing press drive stopping button 57 has been ON, printing is continued. Consequently, the flow returns to step C3, and the sorting of the paper sheet 100 to be sent in next is carried out. When the printing press drive stopping button 57 is ON, the flow proceeds to steps (Routine E shown in FIG. 15) for printing numbers on the single-column defective sheets.

Also in a case where it is determined in step C5 that “a defective pattern exists only in Column E” is false (NO), the flow proceeds to step C9, and whether or not “a defective exists in Column D” is determined. In a case where it is determined that “a defective exists in Column D” (YES), the aforementioned processes of step C10 and steps subsequent thereof are carried out.

In a case where it is determined in step C9 that “a defective pattern exists in Column D” is false (NO), this paper sheet 100 is regarded as that other than the sheets with a defect only in the patterns in Column E and the sheets with a defect only in the patterns in Column D. The paper sheet 100 is then discharged onto the second pile board 21b for being sorted further. That is, the air cylinder (the first-pile discharging air cylinder) 40a in the first delivery cam device 31a is ON, and the air cylinder (second-pile discharging air cylinder) 40b in the second delivery cam device 31b is OFF (Step C15).

The paper sheet 100 is not discharged to the first pile board 21a, and is caused to be discharged (is subjected to second-pile discharge) only onto the second pile board 21b (step C16).

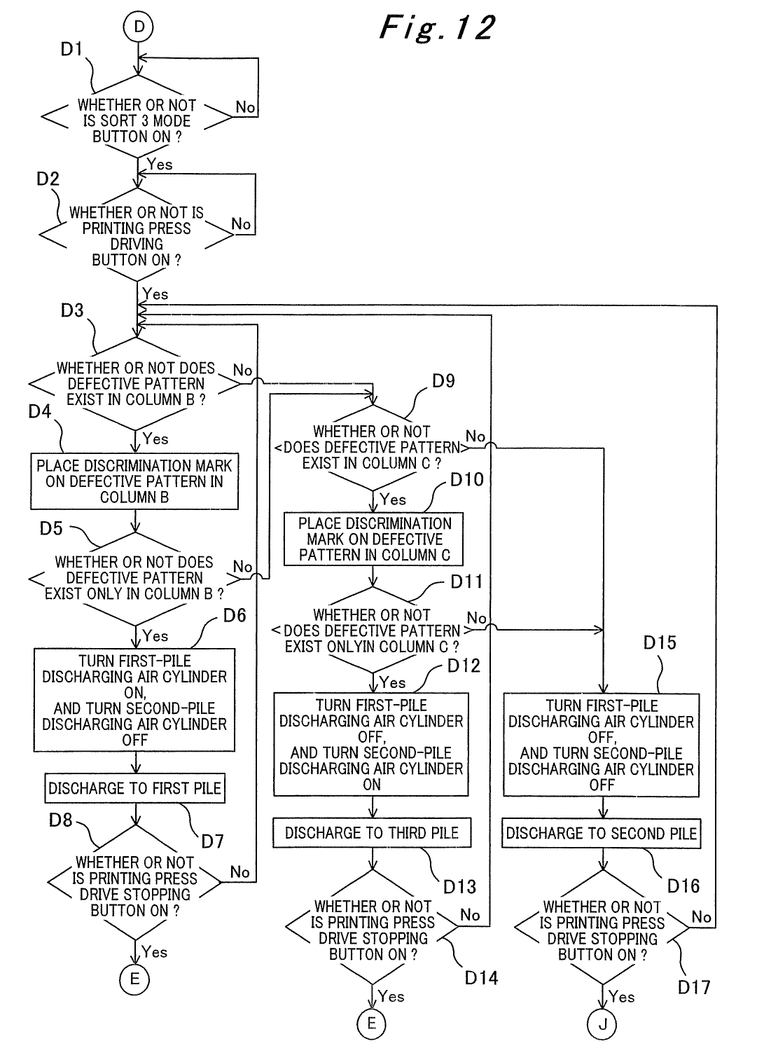

Subsequently, whether or not the printing press drive stopping button 57 is ON is determined (step C17). Unless the printing press drive stopping button 57 has been ON, printing is continued. Consequently, the flow returns to step C3, and the sorting of the paper sheet 100 to be sent in next is carried out. When the printing press drive stopping button 57 is ON, the flow proceeds to steps (Routine D shown in FIG. 12) for further sorting (Sort 3).

As has been described above, in the Sort 2 mode, the paper sheets 100 are sorted into those with a defective only among the patterns in Column E, those with a defective only among the patterns in Column D, and those other than the above types of paper sheets 100, all of which are accumulated respectively on the first pile board 21a, on the third pile board 21c, and on the second pile board 21b. Because the sheets with a defective only among the patterns in Column A have been sorted, the sheets which are other than the sheets with a defective only among the patterns either in Column E or in Column D, and which are accumulated on the second pile board 21a, include: the sheets with a defective only among the patterns either in Column B or in Column C; and the sheets with a defective among the patterns in the plurality of columns. FIG. 20C schematically expresses the condition of this flow.

In the Sort 2 mode, the first pile board 21a is used as a location where the single-group defective sheet materials, which have a defective in Column E, are discharged, and the first delivery cam device 31a over the first pile board 21a is the single-group defective sheet material discharge means. The third pile board 21c is used as the single-group defective sheet materials, which have a defect in Column D, are discharged, and the fixed delivery cam 42 over the third pile board 21c is the single-group defective sheet material discharge means.

<Sort 3 Mode>

Next, a Sort 3 mode will be described on the basis of FIG. 12. The Sort 3 mode is a mode for further sorting the sheets which are accumulated on the second pile board 21b in the Sort 2 mode, and which include those with a defective only among the patterns in Column B or C, and those with a defective among the patterns in the plurality of columns. In order to execute this operation, the paper sheets 100 accumulated on the second pile board 21b in the Sort 2 mode are initially set in the feeder 2 of the printing press 1. Subsequently, the Sort 3 mode button 55 on the operation panel is turned ON, and the printing press driving button 56 is concurrently turned ON. Incidentally, in the printing press 1, all of the pile boards 21a, 21b and 21c in the delivery unit 4 are empty.

First, whether or not the Sort 3 mode button 55 is ON is determined (step D1). When it is determined that the Sort 3 mode button 55 is not ON (NO), this determination is repeated until the Sort 3 mode button 55 is ON.

When it is determined that the Sort 3 mode button 55 is ON, whether or not the printing press driving button 56 is ON is subsequently determined (step D2). When it is determined that the printing press driving button 56 is not ON (NO), this determination is repeated until the printing press driving button 56 is ON.

When the Sort 3 mode button 54 is turned ON, and when the printing press driving button 56 is also turned ON, the paper sheets 100 set in the feeder 2 of the printing press 1 are sent out one by one by the paper feeding device 6. In this Sort 3 mode, as in the case with the other sorting modes, the printing unit 3 does not function. Each of the paper sheets 100 passes by the printing unit 3, and thus reaches the delivery unit 4. Then, the paper sheets 100 are transported by the transport chain 19 in a manner similar to the case with the print mode described above.

Subsequently, determination is made whether or not the paper sheet 100 with a defective pattern is that with a defective among the patterns in Column B (step D3). In a case where a defect exists in at least one of the patterns in Column B, it is determined that “a defective exists in Column B” (YES).

When it is detected that a defective exists among patterns in Column B, a drive signal is issued to the marking device 28 by the control device 51. Thereby, by use of ink, the discrimination mark 102 (refer to FIG. 7) is placed onto the defective pattern 101a existing in Column B (Step D4).

Subsequently, determination is made whether or not the paper sheet 100 with a defective pattern has a defective in a single column. That is, determination is made whether or not a defective pattern exists only among the patterns in Column B (step D5). Cases where a defective pattern exists only among the patterns in Column B include not only a case where all of the patterns in Column B are defectives, but also cases where at least one of the patterns in Column B is the defective pattern 101a as shown in FIG. 7.

In a case where a defective exists only among the patterns in Column B, this sheet is sorted out as the single-column defective sheet (the single-group defective sheet). This sorting is carried out by allowing this paper sheet 100 to be discharged only onto the first pile board 21a. That is, the air cylinder (the first-pile discharging air cylinder) 40a in the first delivery cam device 31a is turned ON, and the air cylinder (the second-pile discharging air cylinder) 40b in the second delivery cam device 31b for making delivery to the second pile board 2 lb is turned OFF (step D6).

By turning the air cylinder 40a in the first delivery cam device 31a ON, the cam follower 24 of the gripper 23 of the gripper device 18 is engaged with the delivery cam 33. Thereby, the gripper 23 opens, and the paper sheet 100 is discharged (is subjected to first-pile discharge) onto the first pile board 21a (step B7).

Subsequently, whether or not the printing press drive stopping button 57 is ON is determined (step D8). Unless the printing press drive stopping button 57 has been ON, printing is continued. Consequently, the flow returns to step D3, and the sorting of the paper sheet 100 to be sent in next is carried out. When the printing press drive stopping button 57 is ON, the flow proceeds to steps (Routine E shown in FIG. 15) for printing numbers on the single-column defective sheets.

With respect to the paper sheet 100 with respect to which it has been determined in step D3 that “a defective pattern exists in Column B” is false, i.e., that any defective exists among the patterns in the columns other than Column B (regardless of whether the defective exists only in one of, or in each of plural ones of those columns), whether or not any defective exists among the patterns in Column C is determined (step D9).

When it is determined that a defective exists in Column C (YES), a drive signal is issued to the marking device 28 by the control device 51. Thereby, by use of ink, the discrimination mark 102 (refer to FIG. 7) is placed onto the defective pattern 10 la existing in Column C (Step D10).

Subsequently, determination is made whether or not the paper sheet 100 with a defective pattern is the single-column defective sheet (the single-group defective sheet). That is, determination is made whether or not any defective pattern exists only among the patterns in Column C (step D11). Cases where any defective pattern exists only among the patterns in Column C include not only a case where all of the patterns in Column C are defectives, but also a case where at least one of the patterns in Column C is the defective pattern 101a as shown in FIG. 7.

In a case where a defective exists only among the patterns in Column C, this sheet is sorted out as the single-column defective sheet. This sorting is carried out by causing this paper sheet 100 to be discharged only onto the third pile board 21c. That is, the air cylinders (the first-pile and second-pile discharging air cylinders) 40a and 40b in the respective first and second delivery cam devices 31a and 31b are both turned OFF (step D12).

By turning both of the air cylinders 40a and 40b in the respective first and second delivery cam devices 31a and 31b OFF, the delivery cams 33 are prevented from contributing to operations of opening the gripper 23 of the gripper device 18. Hence, the gripper 23 does not open over the first and second pile boards 2la and 2lb. Instead, the gripper 23 opens by being engaged with the fixed delivery cam 42 located over the third pile board 21c. Thereby, the paper sheet 100 is discharged (is subjected to third-pile discharge) onto the third pile board 21c (step D13).

Subsequently, whether or not the printing press drive stopping button 57 is ON is determined (step D14). Unless the printing press drive stopping button 57 is ON, printing is continued. Consequently, the flow returns to step D3, and the sorting of the paper sheet 100 to be sent in next is carried out. When the printing press drive stopping button 57 is ON, the flow proceeds to steps (Routine E shown in FIG. 15) for printing numbers on the single-column defective sheets.

Also in a case where it is determined in step D5 that “a defective pattern exists only in Column B” is false (NO), the flow proceeds to step D9, and whether or not “a defective exists in Column C” is determined. In a case where it is determined that “a defective exists in Column C” (YES), the aforementioned processes of step D10 and steps subsequent thereof are carried out.

In a case where it is determined in step D9 that “a defective pattern exists in Column D” is false (NO), this paper sheet 100 is regarded as that other than the sheets with a defect only in the patterns in Column B and the sheets with a defect only in the patterns in Column C. The paper sheet 100 is then discharged onto the second pile board 21b. That is, the air cylinder (the first-pile discharging air cylinder) 40a in the first delivery cam device 31a is OFF, and the air cylinder (second-pile discharging air cylinder) 40b in the second delivery cam device 31b is ON (step D15).

The paper sheet 100 is not discharged to the first pile board 21a, and is caused to be discharged (is subjected to second-pile discharge) only onto the second pile board 21b (step D16).

Subsequently, whether or not the printing press drive stopping button 57 is ON is determined (step D17). Unless the printing press drive stopping button 57 is ON, printing is continued. Consequently, the flow returns to step D3, and the sorting of the paper sheet 100 to be sent in next is carried out. When the printing press drive stopping button 57 is ON, the flow proceeds to steps (Routine J shown in FIG. 19) for sorting small-cut pieces.

As has been described above, in the Sort 3 mode, the paper sheets 100 are sorted into those with a defective only among the patterns in Column B, those with a defective only among the patterns in Column C, and those other than the above paper sheets 100, all of which are accumulated respectively on the first pile board 21a, on the third pile board 21c, and on the second pile board 21b. Incidentally, the sheets which are other than the sheets with a defective only among the patterns either in Column B or in Column C, and which are accumulated on the second pile board 21b only include the plural-column defective sheets (the plural-group defective sheet materials) which have a defective among the patterns in the plurality of columns. This is because the sheets with a defective only among the patterns in Column A have been sorted in the Sort 1 mode; the sheets with a defective only among the patterns in Column E and those with a defective only among the patterns in Column D have been sorted in the Sort 2 mode; and the sheets with a defective only among the patterns in Column B and those with a defective only among the patterns in Column C have been sorted in the Sort 3 mode. FIG. 20D schematically expresses the condition of this flow.

In the Sort 3 mode, the first pile board 21a is used as a location where the single-group defective sheet materials, which have a defective in Column B, are discharged, and the first delivery cam device 31a over the first pile board 21a is the single-group defective sheet material discharge means. The third pile board 21c is used as the single-group defective sheet materials, which have a defect in Column C, are discharged, and the fixed delivery cam 42 over the third pile board 21c is the single-group defective sheet material discharge means. The second pile board 21b is used as a location where the plural-group defective sheets are discharged, and. the second delivery cam device 31a over the second pile board 21b is the plural-group defective sheet discharge means.

As has been described above, the paper sheets 100 are subjected to the print mode, the Sort 1 mode, the Sort 2 mode, and the Sort 3 mode, and thus are sorted into:

(1) those which have no discrimination marks placed thereon, and on which all of the patterns are determined to be non-defectives (Category 1);

(2) those each of which has a discrimination mark only in Column A, the discrimination mark indicating the pattern determined to be defective (Category 2);

(3) those each of which has a discrimination mark only in Column B, the discrimination mark indicating the pattern determined to be defective (Category 2);

(4) those each of which has a discrimination mark only in Column C, the discrimination mark indicating the pattern determined to be defective (Category 2);

(5) those each of which has a discrimination mark only in Column D, the discrimination mark indicating the pattern determined to be defective (Category 2);

(6) those each of which has a discrimination mark only in Column E, the discrimination mark indicating the pattern determined to be defective (Category 2); and

(7) those each of which has discrimination marks in the plurality of columns, the discrimination marks respectively indicating the patterns determined to be defective (Category 3).

Each of the categories of the paper sheets 100 thus sorted are subjected to subsequent steps. Incidentally, the sheets of the same kind (for example, those with a defective only in Column A) are kept in stock until the sheets reach a certain number. Thereafter, the subsequent steps are executed. <Further sorting, and number printing processes>The paper sheets 100 of Category 1 on which all of the patterns are determined to be non-defectives, are transferred to the numbering and imprinting machine shown in FIGS. 5 and 6, and these paper sheets 100 are subjected to number printing. A procedure of the number printing is as shown in FIG. 13. First, the non-defective sheets are set in the feeder of the numbering and imprinting machine, and a driving button thereof is turned ON. In a control system, whether or not the driving button is ON is determined (step A1). When the driving button is not ON, this determination is repeated. When the driving button is ON, the number printing is carried out (step A2). That is, numbers are serially printed in predetermined positions on all of the patterns on each of the sheets. Subsequently, whether or not a drive stopping button is ON is determined (step A3). When the drive stopping button is not ON, the number printing is continued. When the drive stopping button is ON, the number printing is terminated. The sheets on which the numbers are printed are caused to undergo subsequent cutting steps (Routine K shown in FIG. 14).

Each of the paper sheets 100 passes through an interstice between the numbering device 68 of the numbering cylinder 65 and the impression cylinder 75. Thereby, numbers are printed on all of the patterns on each of the paper sheets 100.

The paper sheets 100, on which the numbers are printed, are transferred to the cutting machine to be cut. A procedure of the cutting is as shown in FIG. 14. After the paper sheets 100 are set in the cutting machine, a driving button thereof is turned ON. In a control system, whether or not the driving button is ON is determined (step K1). When the driving button is not ON, this determination is repeated. When the driving button is ON, the cutting is carried out (step K2). That is, the paper sheets 100 are cut into the small-cut piece printed products 101 which are bank notes, securities or the like. Subsequently, whether or not a drive stopping button is ON is determined (step K3). When the drive stopping button is not ON, the cutting is continued. When the drive stopping button is ON, the cutting is terminated. Thereby, the sheets are made to be final products which are bank notes, securities or the like.

Processes for the paper sheets 100 in (2) to (6) (Category 2) described above, each of which has a defective in a single column, will be described with reference to flowcharts in FIGS. 15 to 18. Note that the identical process is performed in all of cases regardless of which one of Columns A to E has the defective.

First, a process shown in FIG. 15 is performed. A bundle (a pile) of the paper sheets 100 each with a defective among the patterns in a single group (for example, Column A) are set in the numbering and imprinting machine. In the numbering and imprinting machine, the numbering devices 68a corresponding to the column with a defective are turned OFF (step El). That is, the numbering devices 68a for printing numbers in Column A are caused to not function. Means such as removing all of the numbering devices 68a from the numbering device mounting plate 67a can be considered as means for causing the numbering devices 68a corresponding to Column A to not function.

Subsequently, whether or not the driving button is ON is determined (step E2). When the driving button is not ON, this determination is repeated. When the driving button is ON, the number printing is carried out (step E3). That is, numbers are serially printed in predetermined positions on all of the patterns on each of the sheets except the patterns ill the specific column (for example, Column A).

Thereafter, whether or not the drive stopping button is ON is determined (step E4). When the drive stopping button is not determined to be ON, the number printing is continued. When it is determined to be ON, the number printing is terminated. The sheets, on which the numbers are printed, are caused to undergo subsequent cutting steps (Routine L shown in FIG. 16).

The cutting step is performed according to a procedure shown in the flowchart in FIG. 16.

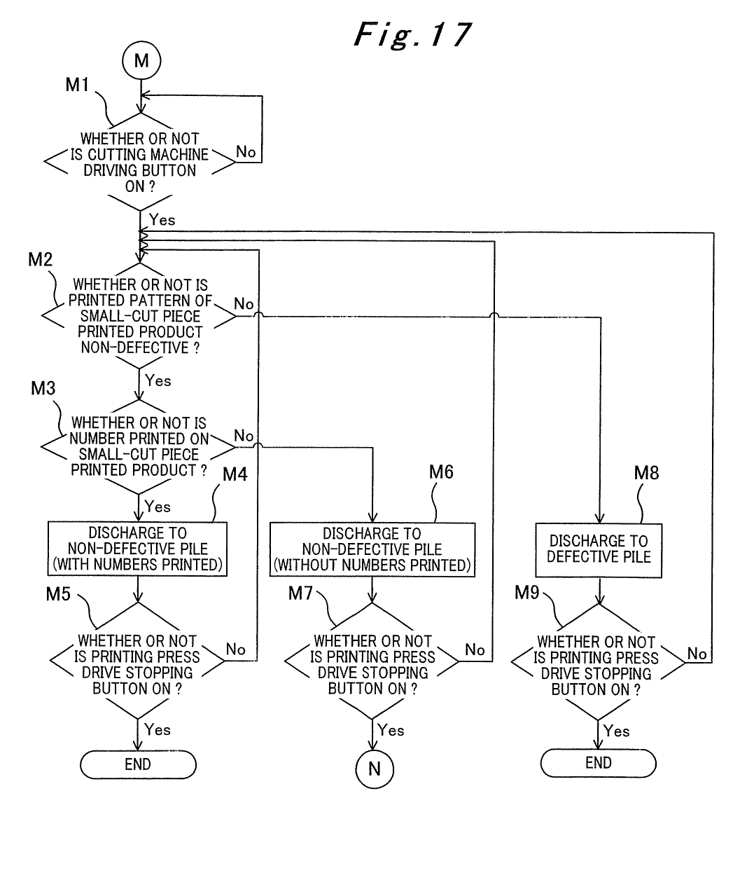

The paper sheets with the numbers printed on the patterns thereof except on those in the specific single group (single column) are set in the cutting machine. The cutting is carried out by turning the driving button of the cutting machine ON. In the control system of the cutting machine, whether or not the driving button is ON is determined (step L1). When the driving button is not ON, this determination is repeated. When the driving button is ON, the cutting is carried out (step L2). That is, the paper sheets 100 are cut into small-cut piece printed products which are bank notes, securities or the like. Subsequently, whether or not the drive stopping button is ON is determined (step A3). When the drive stopping button is not ON, the cutting is continued. When the drive stopping button is ON, the cutting is terminated. Thereby, the printed products (small-cut piece printed products) are caused to undergo subsequent small-cut piece sorting steps (Routine M shown in FIG. 17).

Among the small-cut piece printed products, those on which the numbers are printed, and those on which numbers are not printed, are mixed. Accordingly, the small-cut piece printed products need be sorted into those with numbers printed thereon, and those without numbers printed thereon. This sorting is carried out by means of a sorting machine in accordance with a procedure (Routine M) shown in FIG. 17.

First, a bundle (a pile) of the small-cut piece printed products is set in the sorting machine. Subsequently, a driving button of the sorting machine is turned ON. In a control system, whether or not the driving button is ON is determined (step M1). When the driving button is not ON, this determination is repeated.

If the driving button is ON, whether or not each of the patterns on the small-cut piece printed products is a non-defective or a defective (step M2). As described above, even one defect in the pattern causes the numbering and imprinting machine to not print numbers on the entire column which includes the defect. For this reason, non-defective small-cut piece printed products (patterns) 101 are sorted out of defective small-cut piece printed products 101 in the column determined to have a defective pattern. Determination is also made whether or not each of the small-cut piece printed products 101, which have been determined to be non-defectives, is a non-defective or a defective. The determination on whether or not each of the small-cut piece printed products is a non-defective or a defective is made, for example, on the basis of an image obtained by photographing each of the small-cut piece printed products by use of a photographing device in a manner similar to that for inspections on the sheets. It is needless to mention that the determination may be ¥made by a different method.

Determination is made whether or not each of the small-cut piece printed products determined to be non-defectives has number printed thereon (step M3). When the numbers are printed on these small-cut piece printed products, they are discharged (is subjected to non-defective pile discharge) to a predetermined non-defective (with numbers printed thereon) storage location (step M4).

Thereafter, whether or not a drive stopping button of the sorting machine is ON is determined (step M5). Unless the drive stopping button is ON, sorting is continued. Consequently, the flow returns to step M2, and the sorting of the small-cut piece printed products 101 is repeated. When the drive stopping button of the sorting machine is determined to be ON, the sorting is terminated.

In the above described manner, the small-cut piece printed products 101 which are non-defectives, and which exist in the columns other than the column with a defective pattern 101a of each of the single-column defective sheets, are collected as final products.

The small-cut piece printed products which are determined in step M2 as non-defectives, and which are determined in step M3 as not being those “with numbers printed thereon” are non-defective products in the column which is determined to have been on the single-column defective sheet of any kind, and which has not been subjected to number printing. Hence, these small-cut piece printed products are subjected to the number printing, and are made to be final products. For this reason, the small-cut piece printed products without numbers printed thereon are discharged (are subjected to non-defective pile discharge) to a predetermined non-defective (without numbers printed thereon) storage location (step M16).

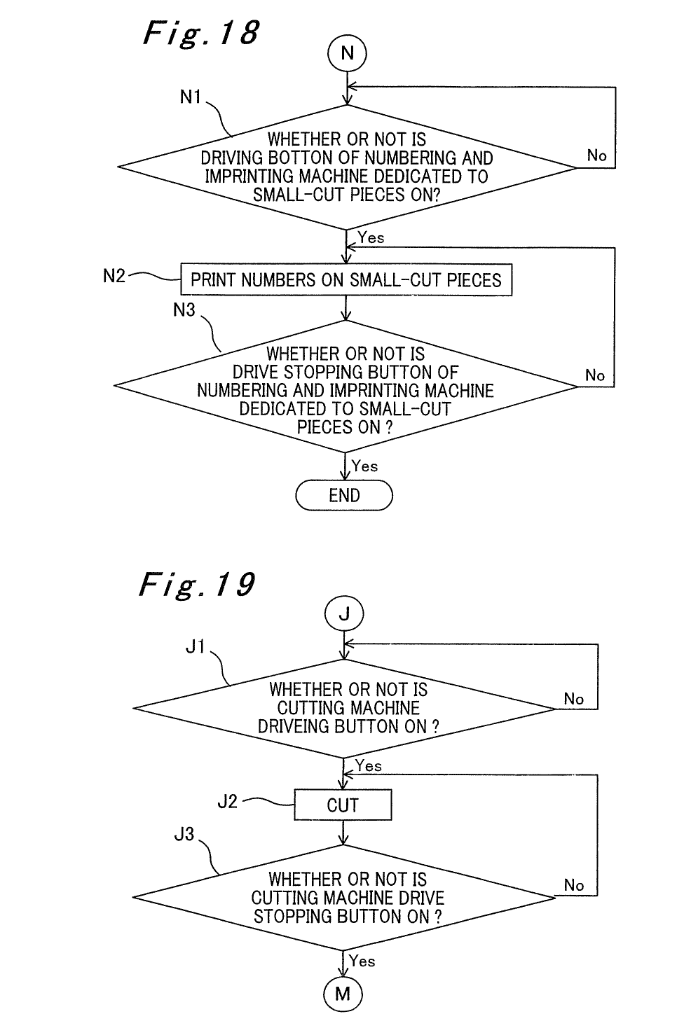

After that, whether or not the drive stopping button of the sorting machine is ON is determined (step M17). Unless the drive stopping button is ON, the sorting is continued. Consequently, the flow returns to step M2, and the sorting of the small-cut piece printed products 101 is repeated. When the drive stopping button of the sorting machine is determined to be ON, the flow proceeds to subsequent steps (Routine N shown in FIG. 18) for performing number printing on the small-cut piece printed products 101.

In a case where it is determined in step M2 that the patterns in the small-cut piece printed products 101 is not a non-defective (NO), these small-cut piece printed products 101 are defective. Consequently, they are discharged (are subjected to defective pile discharge) to a predetermined defective storage location (step M8). Thus, in a case where the pattern is defective, collection is made by small-cut pieces, not by sheets.

Subsequently, whether or not the drive stopping button of the sorting machine is ON is determined (step M9). Unless the drive stopping button is ON, the sorting is continued. Consequently, the flow returns to step M2, and the sorting of the small-cut piece printed products 101 is repeated. When the drive stopping button of the sorting machine is determined to be ON, the sorting is terminated.

The small-cut piece printed products 101 is accumulated in the non-defective (without numbers printed thereon) storage location do not have numbers printed thereon. Consequently, these small-cut piece printed products 101 are caused to undergo the number printing steps as has been described above. This printing is carried out, in accordance with a procedure (Routine N) shown in FIG. 18, by use of a numbering and imprinting machine dedicated to printing numbers on small-cut pieces.

The small-cut piece printed products 101 which are non-defectives, and on which numbers are not printed are set in the numbering and imprinting machine dedicated to small-cut pieces, and a driving button of the numbering and imprinting machine dedicated to small-cut pieces is turned ON. In a control system, whether or not the driving button is ON is initially determined (step N1). Unless the driving button is ON, this determination is repeated.

When the driving button is determined to be ON, numbers are printed on the small-cut pieces (step N2). That is, a number is printed individually on each of the small-cut piece printed products.

When the number printing on the small-cut pieces is completed, determination is made whether or not a drive stopping button of the numbering and imprinting machine dedicated to small-cut pieces is ON (step N3). Unless the drive stopping button is ON, the small-cut piece number printing is continued. Consequently, the flow returns to step N2, and number printing on the small-cut piece printed products 101 is carried out. When the drive stopping button of the numbering and imprinting machine is determined to be ON, the number printing is terminated.

In the manner having been described above, non-defectives having existed in the column with a defective pattern are complete as final products.

A process for the paper sheets 100 of (7) (Category 3) described above will be described. Each of the paper sheets 100 of (7) has defectives in the plurality of columns.

Such paper sheets 100 are cut into small-cut pieces by means of the cutting machine. FIGS. 8A to 8H conceptually express the process. Sheets shown in FIGS. 8A to 8E are those subjected to the processes shown in FIGS. 8F to 8H.

Cutting steps are carried out in accordance with a procedure (Routine J) shown in the flowchart of FIG. 19.

The paper sheets 100 each with defectives in the plurality of columns are set in the cutting machine. The driving button of the cutting machine turned ON, and thus the cutting is carried out. In the control system, whether or not the driving button is ON is determined (step J1). Unless the driving button is ON, this determination is repeated. When the driving button has been ON, the cutting is carried out (step J2). That is, the paper sheets 100 are cut into small-cut piece printed products which are bank notes, securities or the like (refer to FIG. 8F). Subsequently, determination is made whether or not the drive stopping button of the cutting machine is ON (step J3). Unless the drive stopping button is ON, the cutting is continued. When the drive stopping button is ON, the cutting is terminated.

The individually-cut printed products (small-cut piece printed products) which are bank notes or the like are sorted into: those which are non-defectives and have numbers printed thereon; those which are non-defectives, and on which numbers are not printed; and defectives (refer to FIG. 8G). The small-cut piece printed products determined as non-defectives are further caused to undergo the steps shown in FIG. 18. Accordingly, numbers are printed on these small-cut piece printed products, and the resultant printed products are made to be final products. The defectives are discarded (refer to FIG. 8H).

As has been described above, the sheets are subjected to the steps shown in FIGS. 13 to 19, and are thus sorted into categories described in (1) to (7) (Categories 1 to 3). The resultant sheets are finally sorted into small-cut piece printed products as final products and defective small-cut printed products.

### EMBODIMENT 2

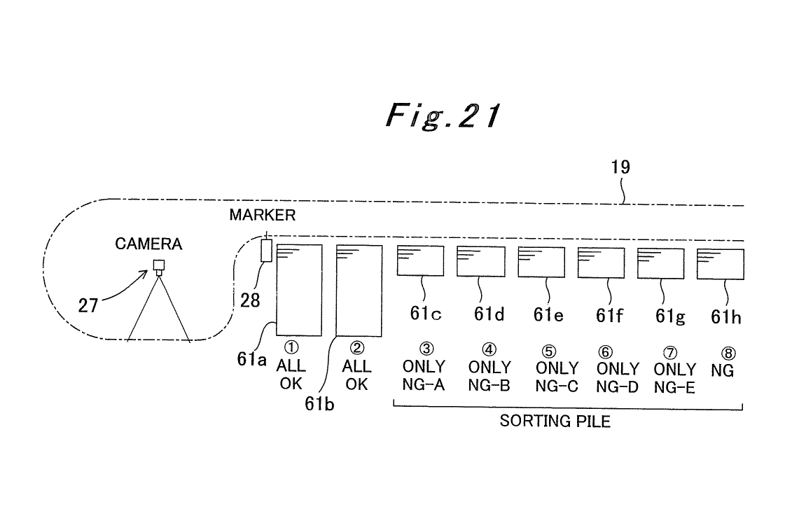

FIG. 21 shows an outline of a sorting apparatus according to Embodiment 2. This sorting apparatus is also incorporated in a discharge unit of a printing press.

Configurations of a feeder and a printing unit in the printing press are identical to those of the delivery unit and printing unit shown in FIGS. 1 and 2. In a delivery unit thereof, seven pile boards 61a, 61b, 61c, 61d, 61e, 61f,61g and 61h are disposed. In a part over each of the pile boards 61a to 61g, a delivery cam device identical to that shown in FIG. 3 is provided. In a part over the pile board 61h, a fixed delivery cam is provided.

The first two pile boards 61a and 61b are pile boards onto which non-defective sheets are discharged. That is, the first two pile boards 61a and 61b are respectively locations where the non-defectives are discharged, and the delivery cams located over the respective boards are non-defective sheet discharge means.

The pile boards 61c to 61g are pile boards onto which sheets each with a defect only in any one of Columns A to E are discharged. That is, the pile boards 61c to 61g are locations where the single-group defective sheet products with a defect respectively in Column A to E are discharged. The delivery cams over the respective boards are the means which discharges the single-group defective sheets with a defect respectively in Columns A to E.

The pile board 61h is a pile board onto which sheets each with defects in a plurality of columns are discharged. That is, the pile boards 61h is a location where the plural-group defective sheets are discharged, and the delivery cam over this board is plural-group defective sheet discharge means.

By disposing the pile boards 61a to 61h in this manner, the sorting into (1) to (7) (Categories 1 to 3) described above can be carried out at once. Thereby, time required for the sorting can be reduced.

Each of the above two embodiments describes a sorting apparatus (a sorting function) incorporated in a printing press. Meanwhile, the sorting apparatus may be configured as an independent apparatus.

### EMBODIMENT 3

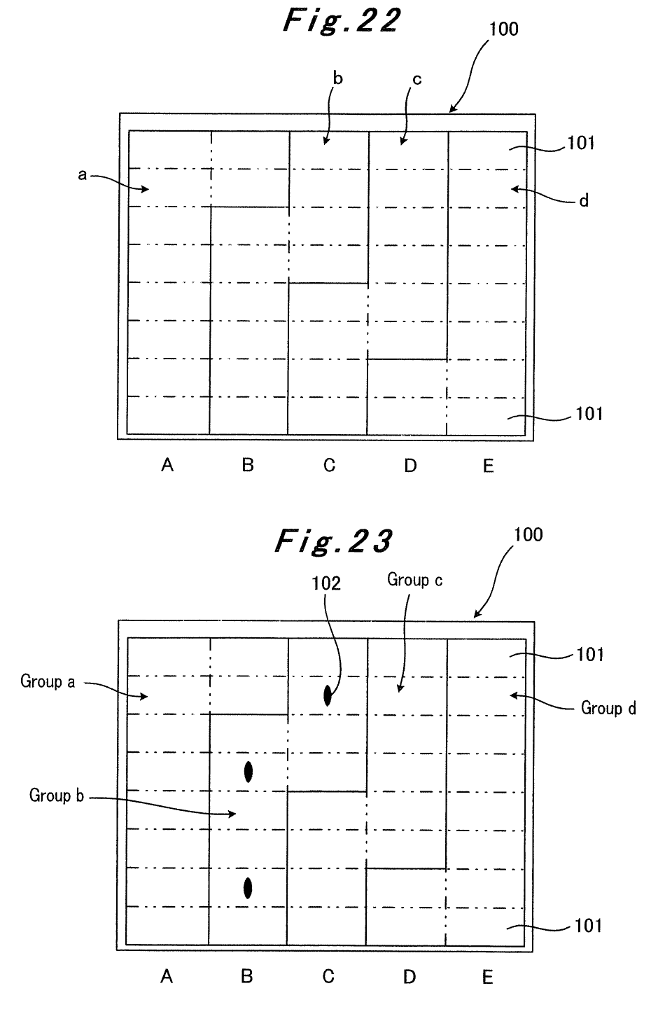

FIGS. 22 and 23 show an example of a grouping different from those in the above embodiments.

The fact that patterns in five columns and eight rows are printed on each of the paper sheets 100 is the same as that in the foregoing embodiments. This grouping is done by dividing is to divide the patterns into groups each including ten small-cut piece printed products 101. The groups a, b, c and e are formed in a manner that each of the groups extends over two adjacent columns (borders between the groups are indicated by thick solid lines in FIGS. 22 and 23).

Also in a case of grouping the patterns in this manner, sheets on each of which all of the patterns are non-defectives are sorted out as non-defective paper sheets, paper sheets each with a defective pattern only in one of the groups a to d are sorted out as single-group defective paper sheets (sheets), paper sheets each with a defective patterns in the plurality of groups a to d are sorted out as plural-group defective paper sheets (sheets).

Even in a case where a defective pattern exists only in one of the groups, each of the groups extends over the plurality of columns. For this reason, when printing the sheets by means of a numbering and imprinting machine, causing only numbering devices each corresponding to one of the columns to not function is not sufficient for the printing to be done.

For example, in a case where three defective patterns 101a exist in the group b as shown in FIG. 23, the numbering devices 68 corresponding to six patterns in the group b among the numbering devices 68 corresponding to Column B, and the numbering devices 68 corresponding to four patterns in the group b among the numbering devices 68 corresponding to Column C, are removed from the numbering device mounting plates 67a to 67e. By removing these numbering devices 68 in this manner, the number printing is not performed on the group b. Incidentally, for example, in a case where serial numbers are printed on the group a, the printing is made in a manner that numbers 1 to 8 are printed respectively on eight patterns 101 in the group a, the patterns 101 belonging to Column A; and numbers 9 and 0 are printed respectively on two patterns 101 in the group b which belong to Column B. The numbering devices 68 are set in this manner. The same numbering method is applied to the patterns in other groups.

As described above, by forming the groups in a manner that each of the groups extends over the plurality of columns, number printing for ten consecutive numbers is made possible. Accordingly, management of the printing is made easier than otherwise. This grouping is extremely effective in such a case where patterns in different sizes are printed on sheets with fixed sizes.

The non-defective sheets are set to be the sheets of a specific kind in each of the above described embodiments. Meanwhile, the single-group defective sheets or plural-group defective sheets are set to be the sheets of the specific kind. For example, in a case where the sheets of the specific kind are set to be the single-group defective sheets with a defective pattern in Column C, the remaining sheets include the non-defective sheets; the single-group defective sheets with a defective pattern in any one of Columns A, B, D and E; and the plural-group defective sheets with a defects among the patterns in the plurality of groups. On the other hand, in a case where the sheets of the specific kind are set to be the plural-group defective sheets, the remaining sheets include the non-defective sheets, and the single-group defective sheets with a defective pattern in any one of Columns A, B, C, D and E.

The method of, and the apparatus for, sorting the sheets according to the present invention are applied to the sorting of sheet-like printed products which are bank notes, securities or the like. The method and the apparatus can be applied to all of the sorting of non-defectives and defectives of sheets on each of which a large number of patterns are placed by printing or the like.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A sheet sorting method, in which sheets, each of which with a plurality of patterns, printed thereon are inspected with respect to a printing quality of the patterns, and in which the sheets are sorted and discharged on the basis of results of the inspections, the method comprising:
sorting into and discharging the sheets as: non-defective sheets on which all of the patterns are determined as non-defectives; single-group defective sheets each determined to have a defective pattern only in one of a plurality of groups formed by grouping the plurality of patterns into the plurality of groups; and plural-group defective sheets each determined to have a defective pattern in each of at least two groups out of the plurality of groups into which the plurality of patterns are grouped.

2. The sheet sorting method according to claim 1, further comprising:
printing a plurality of patterns in a longitudinal direction and in a lateral direction on each of the sheets, and
forming each of the groups of any one of: patterns in each of the columns extending in the longitudinal direction; patterns in each of the rows extending in the lateral direction; and a predetermined number of patterns extending across a plurality of columns or rows.

3. The sheet sorting method according to any one of claims 1 and 2, further comprising:
placing a mark on a defective pattern on each of the single-group defective sheets.

4. The sheet sorting method according to any one of claims 1 and 2, wherein the single-group defective sheets, which have a defective pattern in the same group as that of one another, are sorted out and discharged.

5. The sheet sorting method according to any one of claims 1 and 2, wherein numbers are printed on the patterns in the groups on the single-group defective sheets in which groups non-defective patterns exist.

6. The sheet sorting method according to claim 5, further comprising:
cutting the single-group defective sheets on which numbers are printed, and thereby making them into small-cut piece printed products; and
subsequently sorting the small-cut piece printed products into those with non-defective patterns and with numbers printed thereon, those with non-defective patterns and without numbers printed thereon, and those with defective patterns.

7. The sheet sorting method according to any one of claims 1 and 2, further comprising:
cutting the plural-group defective sheets into the patterns and thereby making them into small-cut piece printed products; and
subsequently sorting the small-cut piece printed products into those with non-defective patterns, and those with defective patterns.

8. The sheet sorting method according to claim 1, wherein:
the non-defective sheets are discharged to a non-defective sheet discharge location;
the single-group defective sheets are discharged to a single group defective sheet discharge location; and
the plural-group defective sheets are discharged to a plural-group defective sheet discharge location.

9. The sheet sorting method according to claim 1, wherein, by inspecting a quality of each of the sheets more than once, the sheets are sorted into, and are discharged as, the non-defective sheets, the single-group defective sheets and the plural-group defective sheets.

10. The sheet sorting method according to claim 9, further comprising:
sorting the non-defective sheets, the single-group defective sheets and the plural-group defective sheets into sheets of a specific kind and remaining sheets, and thereby discharging the sorted sheets,
inspecting the quality of the remaining sheets again when a plurality of kinds of sheets among the non-defective sheets, the single-group defective sheets and the plural-group defective sheets are mixed in the remaining sheets, and
sorting out the sheets of a specific kind out of the remaining sheets, and thereby discharging the sorted sheets.

11. The sheet sorting method according to claim 10, wherein inspection on the quality of the sheets, and sorting out and discharging sheets of the specific kind are repeated until the remaining sheets do not include a plurality of kinds of sheets

12. The sheet sorting method according to claim 10, further comprising:
sorting out, and discharging the non-defective sheets and the remaining sheets by an initial inspection on a printing quality;
subsequently sorting out, and discharging the single-group defective sheets of one type or the single-group defective sheets of a plurality of types which are sorted out and discharged by types, and the remaining sheets by an inspection on the printing quality of the remaining sheets;
sorting out, and discharging at least the single-group defective sheets of one type, and the remaining sheets; and
sorting out, and discharging the single-group defective sheets by inspecting the printing quality until the remaining sheets include only the plural-group defective sheets.

13. The sheet sorting method according to claim 9, wherein
a number of a plurality of discharge locations where the sheets are discharged is set smaller than a total number of sorts of non-defective sheets, single-group defective sheets, and plural-group defective sheets, which are finally sorted out and discharged, and
every time a printing quality is inspected, one or more discharge locations among the plurality of discharge locations are set as one type or a plurality of types of discharge locations among: a non-defective sheet discharge location where the non-defective sheets are discharged; a single-group defective sheet discharge location where the single-group defective sheets are discharged; a plural-group defective sheet discharge location where the plural-group defective sheets are discharged; and a remaining sheet discharge location where the remaining sheets, which mixedly include a plurality of kinds of sheets among the non-defective sheets, the single-group defective sheets and the plural-group defective sheets, are discharged.

14. The sheet sorting method according to claim 13, wherein, in the remaining sheets, a plurality of kinds of sheets among the non-defective sheets, the single-group defective sheets, and the plural-group defective sheets are mixed.

15. The sheet sorting method according to claim 1, wherein the non-defective sheets, the single-group defective sheets and the plural-group defective sheets are sorted out, and are discharged by inspecting a printing quality of each of the sheets once.

16. A sheet sorting apparatus which inspects, by use of an inspection device, sheets each with a plurality of patterns printed thereon, with respect to a printing quality of the patterns, and which sorts and discharges the sheets on the basis of results of the inspections, the apparatus comprising:
discharge means which discharges the sheets inspected by the inspection device; and
control means which controls the discharge means on the basis of the results of the inspection so that the discharge means is allowed to sort out, and discharge the sheets as: non-defective sheets on which all of the patterns are determined as non-defectives; single-group defective sheets each determined to have a defective pattern only in one of a plurality of groups formed by grouping the plurality of patterns into the plurality of groups; and plural-group defective sheets each determined to have a defective pattern in each of at least two groups out of the plurality of groups into which the plurality of patterns are grouped.

17. The sheet sorting apparatus according to claim 16, wherein
a plurality of patterns are printed in a longitudinal direction and in a lateral direction on each of the sheets, and
each of the groups is formed of any one of: patterns in each of the columns extending in the longitudinal direction; patterns in each of the rows extending in the lateral direction; and a predetermined number of patterns extending across a plurality of columns or rows.

18. The sheet sorting apparatus according to any one of claims 16 and 17, further comprising:
a marking device which places a mark on a pattern of which quality is determined to be defective by the inspection device.

19. The sheet sorting apparatus according to claim 16, wherein the control means controls the discharge means so that the discharge means is allowed to sort out, and discharge the single defective sheets which have a defective pattern in the same group as that of one another.

20. The sheet sorting apparatus according to claim 16, wherein the discharge means includes:
non-defective sheet discharge means which discharges the non-defective sheets to a non-defective sheet discharge location;
single-group defective sheet discharge means which discharges the single-group defective sheets to a single-group defective sheet discharge location; and
plural-group defective sheet discharge means which discharges the plural-group defective sheets to a plural-group defective sheet discharge location.

21. The sheet sorting apparatus according to claim 16, wherein the control means controls the discharge means in a way that the discharge means:
sorts the non-defective sheets, the single-group defective sheets and the plural-group defective sheets into sheets of a specific kind and remaining sheets;
discharges the thus sorted sheets;
sorts the sheets of a specific kind out of the remaining sheets on the basis of inspections on the quality of the remaining sheets mixedly including a plurality of kinds of sheets among the non-defective sheets, the single-group defective sheets and the plural-group defective sheets; and
discharges the thus sorted sheets.

22. The sheet sorting apparatus according to claim 16, further comprising:
a plurality of discharge locations to which sheets are discharged,
wherein, in the apparatus,
a number of discharge locations is set smaller than a total number of sorts of non-defective sheets, single-group defective sheets, and plural-group defective sheets, which are finally shorted out and discharged, and
every time printing quality is inspected, the control means sets one or more discharge locations among the plurality of discharge locations as any of one type and a plurality of types of discharge locations among:
a non-defective sheet discharge location where the non-defective sheets are discharged;
a single-group defective sheet discharge location where the single-group defective sheets are discharged; a plural-group defective sheet discharge location where the plural-group defective sheets are discharged; and
a remaining sheet discharge location where the remaining sheets, which mixedly include a plurality of kinds of sheets among the non-defective sheets, the single-group defective sheets and the plural-group defective sheets, are discharged.

23. The sheet sorting apparatus according to claim 22, wherein a plurality of kinds of sheets among the non-defective sheets, the single-group defective sheets, and the plural-group defective sheets are mixed in the remaining sheets.

24. The sheet sorting apparatus according to claim 16, further comprising:
a plurality of discharge locations where sheets are discharged,
wherein, in the apparatus, the discharge locations, of which number is equal to that of sorts of sheets finally sorted out and discharged, are provided, the sorts corresponding to the non-defective sheets, the single-group defective sheets and the plural-group defective sheets.

25. The sheet sorting apparatus according to claim 16, further comprising:
transport means which transports the sheets,
wherein, in the apparatus, the transport means is formed by being provided with a sheet gripping device which grips and releases the sheets.

26. The sheet sorting apparatus according to claim 16, wherein the inspection device is configured to photograph patterns on the sheets transported by transport means.
